(19) United States
(12) Patent Application Publication
(10) Pub. No.: US 2026/0226958 A1
(43) Pub. Date: Aug. 6, 2026

(54) IN SITU FLYWHEEL BALANCING

(71) Applicant: Torus Inc., South Salt Lake, UT (US)

(72) Inventors: Jon Byman, Sandy, UT (US); Cliff Lambarth, Portage, MI (US); Caleb Larchar, Hyrum, UT (US)

(21) Appl. No.: 19/466,090

(22) Filed: Jan. 30, 2026

Related U.S. Application Data
(60) Provisional application No. 63/752,421, filed on Jan. 31, 2025.

(51) Int. Cl. F16F 15/30

(52) U.S. Cl. CPC F16F 15/30; F16F 2230/0011; F16F 2230/10; F16F 2232/02

(57) ABSTRACT

A system may include a massive flywheel including a rotatable mass component and one or more axles coupled with the rotatable mass component, the one or more axles extending from a top of the rotatable mass component and from a bottom of the rotatable mass component. The flywheel including a plurality of receptacles. A system may include a balancing slug that deforms when placed into one of the plurality of receptacles.

### BACKGROUND

The present disclosure relates to mechanical energy storage units. Implementations relate to flywheel-based mechanical energy storage units.

Currently, residential electricity customers, as well as electrical utilities, use various sources of electrical energy storage to offset varying electrical power production and use, such as the duck curve associated with solar or other renewable energy production. The variation in power production and usage has been further exacerbated with the increasing popularity of renewable power sources. These issues cause significant cost and other issues to utilities, power outages, and other issues.

Previous solutions for mechanical energy storage have been overly complex, too large to be implemented at a residential level, not scalable for an electrical utility, or have faced other issues. Some solutions use flywheels for energy storage, but the use of flywheels for energy storage presents other problems. For example, flywheels should be precisely balanced because an imbalanced flywheel can be dangerous or have reduced lifespans.

Typically, when balancing a spinning mass component of a flywheel, it is spun with its axis of rotation in a horizontal orientation, calculations are performed using accelerometer readings, and then mass is shaved from the flywheel. By shaving mass from the flywheel, it can be balanced. Unfortunately, these methods are insufficient when a flywheel needs to be re-balanced or when the flywheels are composed of multiple components, such as a stack of plates where the plates may shift during transport or use. The previous balancing technologies also faced many other problems. For example, because an energy-storage flywheel is far heavier than typical structures that are spin-balanced, the actual structure of the flywheel, installation, or balancing apparatus may change under load, so orientation and configuration affect precision during balancing.

### SUMMARY

In some aspects, the techniques described herein relate to a system including: a flywheel including a rotatable mass component and one or more axles coupled with the rotatable mass component, the one or more axles extending from a top of the rotatable mass component and from a bottom of the rotatable mass component, the flywheel including a plurality of receptacles; and a balancing slug that deforms when placed into one of the plurality of receptacles.

In some aspects, the techniques described herein relate to a system, further including: an enclosure enclosing the flywheel, the enclosure including a balancing access port adjacent to at least one of the plurality of receptacles, the balancing access port allowing the balancing slug to be inserted through the balancing access port.

In some aspects, the techniques described herein relate to a system, wherein: the enclosure includes a plurality of balancing access ports, the plurality of balancing access ports including the balancing access port on a top of the enclosure and a second balancing access port on a bottom of the enclosure when the enclosure is placed with the one or more axles in a vertical orientation.

In some aspects, the techniques described herein relate to a system, wherein: the enclosure includes a first plurality of balancing access ports on a top of the enclosure and a second plurality of balancing access ports on a bottom of the enclosure when the enclosure is placed with the one or more axles in a vertical orientation.

In some aspects, the techniques described herein relate to a system, further including: a door closing the balancing access port and one or more seals sealing the door to the enclosure.

In some aspects, the techniques described herein relate to a system, wherein: the door includes a transparent window.

In some aspects, the techniques described herein relate to a system, further including: the door includes a mirror coupled with the transparent window, the mirror being angled to allow visibility inside the enclosure toward the one or more axles through the transparent window.

In some aspects, the techniques described herein relate to a system, wherein: the balancing slug includes a circumferential ridge that is constructed from a softer material than a receptacle of the plurality of receptacles of the flywheel, the circumferential ridge deforming when the balancing slug is installed in the receptacle.

In some aspects, the techniques described herein relate to a system, wherein: the balancing slug includes a plurality of fingers that flex relative to one another, the plurality of fingers being pressed toward a center axis of the balancing slug when the balancing slug is inserted into a receptacle of the plurality of receptacles.

In some aspects, the techniques described herein relate to a system, wherein: the balancing slug has a substantially cylindrical body, the balancing slug including a center channel extending along a longitudinal axis of the substantially cylindrical body, the center channel receiving at least one weight.

In some aspects, the techniques described herein relate to a system, wherein: the at least one weight includes a set screw that screws into threads located within the center channel.

In some aspects, the techniques described herein relate to a system, wherein: the set screw exerts a circumferential force on the center channel when the set screw is screwed into the center channel, the circumferential force causing a surface of the balancing slug to be pressed into a second surface of a receptacle of the plurality of receptacles.

In some aspects, the techniques described herein relate to a system, wherein: the center channel is configured to receive multiple set screws simultaneously.

In some aspects, the techniques described herein relate to a system, wherein: each receptacle of the plurality of receptacles includes a recess with a substantially cylindrical shape extending in an axial direction of the flywheel.

In some aspects, the techniques described herein relate to a system, wherein: the rotatable mass component includes two clamping plates sandwiching a plurality of stacking plates, each of the two clamping plates including the plurality of receptacles.

In some aspects, the techniques described herein relate to a system, wherein: a first subset of the plurality of receptacles are positioned on a top surface of the rotatable mass component and a second subset of the plurality of receptacles are positioned on a bottom surface of the rotatable mass component.

In some aspects, the techniques described herein relate to a system including: a flywheel including a rotatable mass component and one or more axles coupled with the rotatable mass component, the one or more axles extending from a top of the rotatable mass component and from a bottom of the rotatable mass component, the flywheel including a plurality of receptacles; a balancing slug that deforms when placed into one of the plurality of receptacles, the balancing slug including: a plurality of fingers located around a center channel in a substantially cylindrical body of the balancing slug, the plurality of fingers flexing relative to one another, the plurality of fingers being pressed toward a center axis of the balancing slug when the balancing slug is inserted into a receptacle of the plurality of receptacles, the center channel configured to receive a set screw that exerts a circumferential force on the plurality of fingers when the set screw is placed in the center channel; and the balancing slug includes a circumferential ridge that is constructed from a softer material than the receptacle of the flywheel, the circumferential ridge deforming when the balancing slug is installed in the receptacle of the plurality of receptacles; and an enclosure enclosing the flywheel, the enclosure including a balancing access port adjacent to at least one of the plurality of receptacles, the balancing access port allowing the balancing slug to be inserted through the balancing access port.

In some aspects, the techniques described herein relate to a method of balancing a flywheel including: placing a first balancing slug into a first receptacle on a first plane of the flywheel through a top balancing access port of an enclosure; and placing a first set screw into the first balancing slug while the first balancing slug is in the first receptacle.

In some aspects, the techniques described herein relate to a method, further including: determining a balance of the flywheel inside of the enclosure; and based on the balance of the flywheel, placing a second balancing slug into a second receptacle on a second plane of the flywheel through a bottom balancing access port, and placing a second set screw into the second balancing slug while the second balancing slug is in the second receptacle.

In some aspects, the techniques described herein relate to a method, further including: opening a door closing the top balancing access port; rotating the flywheel within the enclosure until the first receptacle is located proximate to the top balancing access port; and inserting the first balancing slug into the first receptacle through the top balancing access port of the enclosure.

Other implementations of one or more of these aspects or other aspects include corresponding systems, apparatus, and computer programs, configured to perform the various actions and/or store various data described in association with these aspects. These and other implementations, such as various data structures for controlling the mechanical energy storage unit, may be encoded on tangible computer storage devices. Numerous additional features may, in some cases, be included in these and various other implementations, as discussed throughout this disclosure. It should be understood that the language used in the present disclosure has been principally selected for readability and instructional purposes, and not to limit the scope of the subject matter disclosed herein.

### BRIEF DESCRIPTION OF THE DRAWINGS

This disclosure is illustrated by way of example, and not by way of limitation in the figures of the accompanying drawings in which like reference numerals are used to refer to similar elements.

FIG. 1 depicts an example energy as a service platform.

FIG. 2 illustrates an example method of balancing a flywheel.

FIGS. 3A-3D illustrate example flywheel energy storage unit assemblies from various angles.

FIGS. 4A-4C illustrate cross section views of an example balancing access port.

FIGS. 5A and 5B illustrate an example bottom balancing access port with a door in an enclosure.

FIG. 5C illustrates a cross-sectional view of another example flywheel energy storage unit.

FIGS. 6A and 6B illustrate example implementations of a flywheel.

FIG. 6B illustrates another example configuration of a flywheel.

FIGS. 6C-6F illustrate various views of an example balancing slug receptacle.

FIGS. 6G-6I are cross-sectional views illustrating various example configurations of receptacles in association with balancing slugs.

FIGS. 7A-7C illustrate various views of an example balancing expansion slug.

FIG. 7D is a cross-sectional view of an example balancing slug.

FIGS. 7E and 7F illustrate various views of example balancing expansion slugs.

FIG. 8 illustrates an example set screw.

### DETAILED DESCRIPTION

This description includes several improvements over previous solutions, such as those described in reference to the Background. A mechanical-energy storage unit is described herein along technologies for balancing the flywheels, potentially in situ. For example, some aspects of the technology include methods and mechanisms that allow a flywheel to be balanced after it is placed in its case or enclosure, after installation at a deployment location, or during maintenance without removing it to a balancing apparatus, which improves safety, efficiency, and lifespan, such as of bearings or seals.

As noted in the Background, typically, balancing a flywheel with its axis of rotation in a horizontal orientation does not represent real-world deployment and can result in various issues during the process due to the change in configuration, flex of components, or other flywheel-related balancing issues. Previous technologies where mass was removed from a flywheel are not ideal for balancing a flywheel especially after placing it in its enclosure and/or after installation, because this process can cause dust, debris, etc., around bearings, seals, or lose within a case for the flywheel, which can reduce lifespan or even create dangerous projectiles.

As noted elsewhere herein, balancing a flywheel after installation can be beneficial as it allows the flywheel system/assembly to be balanced (e.g., rather than just the spinning mass) and it allows rebalancing after installation and/or during maintenance. Furthermore, aspects of the technology allow a flywheel to be balanced with its axis of rotation in a vertical orientation. These benefits are compounded when the flywheel includes multiple components, such as stacked plates and/or separate axles.

For example, a flywheel may include a rotatable mass component, which may comprise a plurality of stacking plates, cylinders, or other components, one or more bolt or clamping plates, one or more axle members, and other features. For instance, a support structure of a flywheel may include clamping plates that apply pressure to stacking plates, thereby inducing friction between the plates to keep them in place and transfer rotational momentum between the plates and one or more axles. In some implementations, two clamping plates may be clamped together by bolts or other fasteners, which thereby cause the clamping plates to apply pressure on massive plates (e.g., in an axial direction), which may be referred to herein as stacking plates, and increase the friction among the stacking plates, which may, in some cases, allow the stacking plates to be used without other fasteners, thereby improving safety and efficiency. In these and other implementations where a flywheel includes multiple components, the benefit of balancing a flywheel with a vertically oriented axis of rotation, and with the other improvements noted and evident herein, are further compounded. Other features of the flywheel are described below.

The technologies described herein may also include an improved structure, such as an enclosure, and support system, which may include, among other things, a sealed enclosure, a vacuum assembly, a magnetic coupling, a motor, various bearings, and positioning mechanisms. The enclosure may include various features for maintaining a vacuum, holding one or more bearings, positioning a flywheel during use or transport, mitigating damage due to structural failures, and isolating vibration, among other features.

Accordingly, implementations of the technologies described herein may allow balancing of a flywheel within an enclosure (although this is not necessary to realize many of their benefits), which allow the system to be balanced with improved accuracy and other benefits. For example, the technologies may include access one or more access ports that allow the balance or other status of the flywheel to be monitored and/or the balance to be adjusted while the flywheel is inside the enclosure. Some implementations of the flywheel enclosure include ports that allow the flywheel to be accessed at two planes, which allows multi-axis balancing, even while inside the enclosure.

Some implementations of the technology allow the balance to be adjusted without removing material, which leads to a cleaner, safer enclosure and without causing destruction to the flywheel or disassembly of the flywheel energy storage unit assembly. For example, the technologies described herein include various mechanisms for adding mass to the flywheel at designated locations, such as on a top or bottom of the flywheel in holes using specialized weights. Some aspects of the invention allow the weights to be added in an incremental and adjustable fashion while retaining safety during high rotations per minute. For example, simply adhering weights to the flywheel is often not satisfactory due to the serious repercussions of a weight disconnecting (e.g., becoming a projectile within an enclosure) or a flywheel moving off balance (e.g., the extremely high energies of a spinning flywheel can cause significant damage). Furthermore, the massive structure of a flywheel is not typically in a ring inside of which weights could be placed due to structure needed to counteract an extremely large centrifugal pulling force.

Previous flywheel balancing systems shaved material from the flywheel rather than adding weights in part because minute adjustments to the balance are desirable. Additionally, adding weights using adhesive, such as in balancing tires, is not performed in a flywheel because such weights may become detached. As such, they are unsuitable for flywheels, which can rotate at an order of magnitude higher RPMs than a tire and/or with much greater mass. Additionally, a detached weight for a flywheel may become a dangerous and damaging projectile, may become lodged in an axle or bearing, or may result in dangerous imbalance of the flywheel. Accordingly, the balancing expansion slug system described herein provides a minutely adjustable weight that is secured in place at one or more locations of the flywheel.

Other benefits and features are described throughout this disclosure, but it should be noted that other features and benefits are contemplated. Furthermore, while various implementations are described in reference to the figures, these are provided by way of example and their features may be expanded, modified, or removed. For instance, features described in reference to some implementations may additionally or be used with other implementations.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components. Further, it should be noted that while various example features and implementations are described throughout this disclosure and the figures, these examples are not exhaustive of every contemplated implementation, feature or permutation. For instance, while a certain feature may be described in reference to a first implementation, the feature may be used with a second implementation or the features, operations, etc., may otherwise be exchanged between the implementations.

The innovative technology disclosed in this document also provides novel advantages including the ability to integrate modern technology with conventional power infrastructure; enable rapid transition to renewable energy sources; use the power grid as a backup; store power locally in nodes and regionalized storage clusters of nodes; isolate and minimize the impact of power outages; whether caused by natural disasters, infrastructure failure, or other factors; provide affordable alternatives to expensive and environmentally unfriendly electrochemical batteries; provide consumers the option to be independent from carbon-based power sources; and decentralize electric power production.

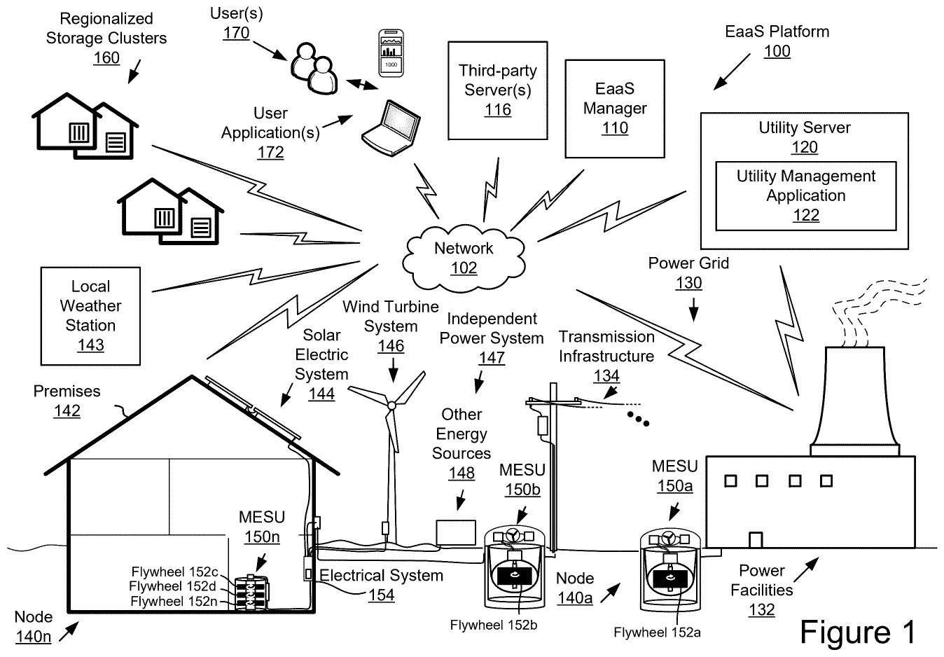

As depicted in FIG. 1, the innovative energy technology described herein may comprise an energy as a service platform (EaaS platform) 100 in which a flywheel energy storage system (also referred to as a FESS, energy storage unit—ESU, or mechanical energy storage unit—MESU) is installed and used. The EaaS platform 100 may include an EaaS manager 110, third-party server(s) 116, user application(s) 172 operable on computing devices accessible to and interactable by user(s) 170 of the EaaS platform 100 and configured to send or receive data to the EaaS manager 110, regionalized storage clusters 160 comprised of one or more nodes 140, and the power grid 130 that comprises one or more power facilities 132 that are connected to a power transmission infrastructure 134.

A node 140a . . . 140n may be comprised of a power consuming entity/load and at least one ESU (e.g., a MESU 150 is provided as an example). A node 140 may be an entity that either consumers power itself or is coupled to entities that consumer power. In some cases, a node 140 may additionally or alternatively produce power. Various nodes 140a . . . 140n are shown as examples, and they may be in the same or disparate locations (e.g., connected by transmission infrastructure 134). In FIG. 1, an example node 140n is depicted as a premises 142, such as a residential home, but it should be understood that any entity that consumes or generates power is applicable, such as one or more appliances, a commercial structure such as a warehouse or office building, an electronic device or system (whether configured to move or static), a transportation system and/or vehicle, a transportation charging system, a power supply, a power substation, a power substation backup, etc. A regionalized storage cluster includes two or more nodes 140 in a given geographical region. A storage cluster may provide power banking functionality, as discussed further herein. The elements of the node 140 including the ESU(s) 150, the independent power system 147, the power grid 130, and/or any appliances and/or other entities, may be electrically coupled via an electrical system 154 including wiring, junctions, switches, plugs, breakers, transformers, inverters, controllers, and any other suitable electrical componentry.

In the depicted example, a node 140 may be equipped with or coupled with power generating technology, such as an independent power system 147 and/or the power grid 130. The independent power system 147 may comprise power generating technology that is localized and that allows for independent power generation, such as renewable power generating technology. Non-limiting examples include a solar electric system 144 (comprising a solar array, controllers, inverters, etc.), a wind turbine system 146 (comprising turbine(s), controllers, inverters, etc.), and/or other energy sources 148, such as hydropower, geothermal, nuclear, systems and their constituent components, etc. The power generating technology may additionally or alternatively be conventional carbon-based power generating technology such as the depicted power grid 130, although for carbon negative or neutral implementation, a greener power generating technology may be preferred.

The node 140 may include or be coupled to an energy storage unit that is capable of storing excess power that is produced by the power generating technology. In some implementations, the energy storage unit may comprise one or more mechanical energy storage units (MESU) 150a . . . 150n. Although the MESU(s) 150 is/are illustrated and described herein as including one or more flywheels 152a . . . 152n (also simply referred to individually or collectively as 152), they may alternatively or additionally include chemical batteries, capacitors, or other energy storage devices. The MESUs 150 may convert the electricity received from the power generating technology to kinetic energy by spinning up (increasing the spin rate) of the flywheels 152 and/or by using one or more inverters that convert between direct current and alternating current, depending on the implementation.

Each battery or flywheel 152 or may be configured to store up to a certain maximum amount of energy. By way of non-limiting example, a motor coupled to the flywheel 152 may be configured to spin the flywheel 152 up to hundreds, thousands, or tens of thousands of rotations per minute (RPM), such that the flywheel 152 may store between several, tens, or more kilowatt hours (kWh) of energy. Combined, multiple flywheels 152 could store tens, hundreds, or thousands of kWh of power, though these are only illustrative examples, and much larger or smaller flywheels or speeds are possible and contemplated. During hours in which the power generation technology, such as the solar cells, produce less power than what is consumed by the electrical apparatuses (e.g., appliances) of the premises 142, the motor may be operated as a generator that converts the kinetic (mechanical) energy stored in the flywheel 152 to electricity, thereby pulling power from the flywheel 152 to meet the local power needs of the node 140 (e.g., power the electrical apparatuses of the premises 142). In this example, the MESU 150 may be capable of powering the node 140 fully for days or weeks and/or may cycle multiple times per day or per hour to address variations in energy production and usage needs.

In some implementations, a premises 142 or node 140 may include or be coupled (physically or communicatively) with a local weather station 143 that measures light, precipitation, wind speed and direction, barometric pressure, or other weather data. For instance, where the premises 142 includes a residence, a local weather station 143 may be placed on a roof or in a yard of the residence. The local weather station 143 may be communicatively coupled directly with a controller or central nervous system of a node 140 or ESU 150 or may be coupled with an EaaS manager 110, third-party server(s) 116, or another device via the network 102, for instance. Accordingly, weather and other context data may be used, as described below, to train one or more machine-learning models that predict power consumption and/or production. The weather data may also be input into a trained model in order to predict future behavior (e.g. power consumption or production), as described elsewhere herein.

In another example, a utility may be integrated with the EaaS manager 110 and its utility management application 122 signal a power management application via the storage cluster APIs that it is experiencing a surge in demand for power, and the power management application may signal a node 140 or cluster of nodes 140 (e.g., storage cluster 160) to spin off power from the flywheels 152 and provide the energy back to the grid through the transmission infrastructure 134, which may be connected to the node(s) 140 through connection points (e.g., two or three phase electrical service drops or buried power lines connected to a service panel, which typically includes power meter(s)). Conversely, the utility may be producing excess power and may wish to bank/store the power. The utility management application 122 may signal the power management application via the storage cluster APIs that it needs to store a given amount of power, and the power management application may in turn signal a node 140 or cluster(s) of node(s) 140, such as one or more regionalized storage clusters 160 to inform them of the storage need, and node(s) 140 in those storage cluster(s)160 that have excess capacity and are configured to receive power from the grid may receive the power through the transmission infrastructure 134 and store it as mechanical energy in the ESUs for later retrieval. The EaaS platform 100 may charge the utility for the power banking service, as discussed further elsewhere herein.

It should be understood that RPMs and kWh figures provided herein are meant as non-limiting examples and that the MESUs 150 may be configured with flywheels 152 that are capable of storing more or less power depending on the implementation. For example, the weight of the flywheels 152, the materials used for the flywheels 152, the size and configuration of the flywheels 152, the efficiency of the motor and bearings, and so forth, may all be adjusted based on the use case to provide a desired amount of storage or transfer ability. By way of further example, a flywheel 152 may be made of steel, aluminum, carbon fiber, titanium, any suitable alloy, and/or any other material that is capable of handling the cycles, vibration, radial and sheer stress and strain, and other conditions to which such a flywheel 152 would be subjected.

The power transmission infrastructure 134 comprises a power network that couples power-consuming entities, such as homes, offices, appliances, etc., to power facilities that generate power from carbon, nuclear, and/or natural sources. The transmission infrastructure 134 may include intervening elements, such as step-up transformers, substations, transmission lines, and so forth, which are interconnected to provide power widely to different geographical regions.

A power utility (also simply referred to as a utility), which may own and operate one or more power facilities 132 and portions of the transmission infrastructure 134, may operate a utility server configured to execute a utility management application 122. The utility management application 122 may perform various functions such as load balancing, load managing, and grid energy storage, to manage the supply of electricity based on real-time demand. However, given the limitations of existing grid technologies, power outages, brownouts, and expensive peak power costs are still the norm.

As shown in the example, various configurations of MESUs 150 and nodes 140a . . . 140n may be used. For example, one or more MESUs 150 (e.g., 150a, 150b, 150n) may be located at or near and/or associated with a power facility 132 or utility, the MESUs 150 may be located in distributed locations, such as a transformer or step-down facilities, in neighborhoods, at large facilities, such as for manufacturing or other businesses, or at residences. The MESUs 150, whether large or small may be used together, leveraging their locations and capabilities to improve stability and reliability of a power grid 130, a power facility 132, and/or an independent power system 147.

A user may use an instance of a user application 172 executing on a computing device, such as the user's mobile phone or personal computer, to configure and interact with the MESU(s) 150 that they are authorized to control, such as an MESU 150 installed at their home or business, as discussed further elsewhere herein.

As shown in FIG. 1, the EaaS manager 110, the utility server 120, the power facilities 132, elements of the power grid 130, the wind turbine system 146, the solar electric system 144, the other sources 148, the node(s) 140, the regionalized storage clusters 160, the user applications 172 and associated computing devices, etc., may be coupled for communication and connected to the network 102 via wireless or wired connections (using network interfaces associated with the computing devices of the foregoing elements). The network 102 may include any number of networks and/or network types. For example, the network 150 may include one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The EaaS manager 110, the third-party server(s) 116, the utility server 120, the node(s) 140, the power facilities, and the user devices may have computer processors, memory, and other elements providing them with non-transitory data processing, storing, and communication capabilities. For example, each of the foregoing elements may include one or more hardware servers, server arrays, storage devices, network interfaces, and/or other computing elements, etc. In some implementations, one or more of the foregoing elements may include one or more virtual servers, which operate in a host server environment. Other variations are also possible and contemplated.

It should be understood that the EaaS platform 100 and other components illustrated in FIG. 1 are representative of example systems and that a variety of different system environments and configurations are contemplated and are within the scope of the present disclosure. For example, various acts and/or functionality may be moved between entities (e.g., from a server to a client, or vice versa, between servers, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc., without departing from the scope of this disclosure.

The third-party server(s) 116 one or more servers or services that provide additional or outside information. For example, a third-party server 116 may associated with and/or provide interaction with the National Weather Service™, an electric vehicle, a smart EV charger, a smart thermostat, a home automation system, a smart power meter (e.g., an Acrel™ meter), a solar power production service, or various other servers or services. For instance, the EaaS manager 110 and/or a node 140 (e.g., a controller or central nervous system thereof) may communicate with one or more third-party servers 116 to receive power consumption data, power production data, contextual data, or otherwise. In some instances, the one or more third-party servers 116 may additionally or alternatively allow control of various power production devices or power loads.

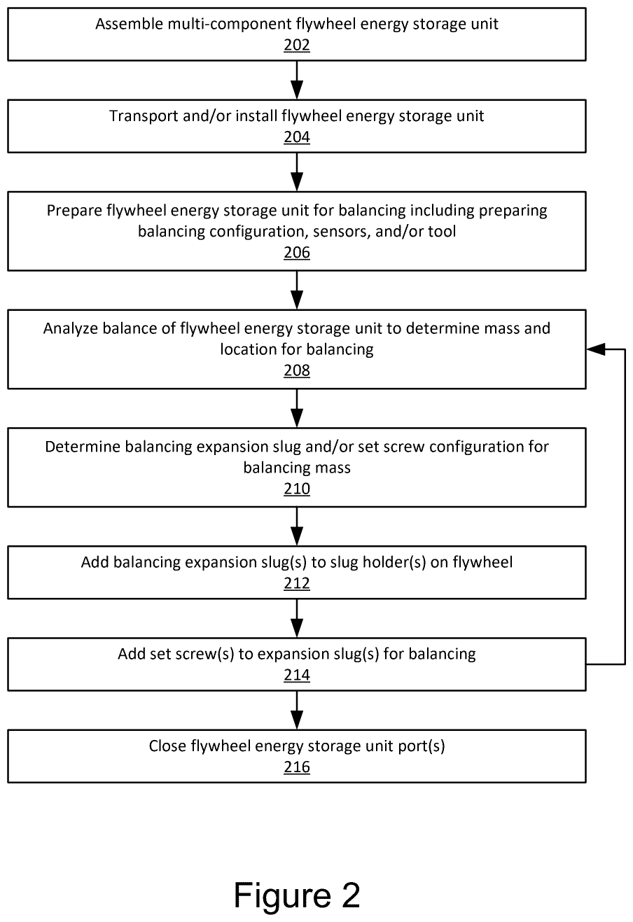

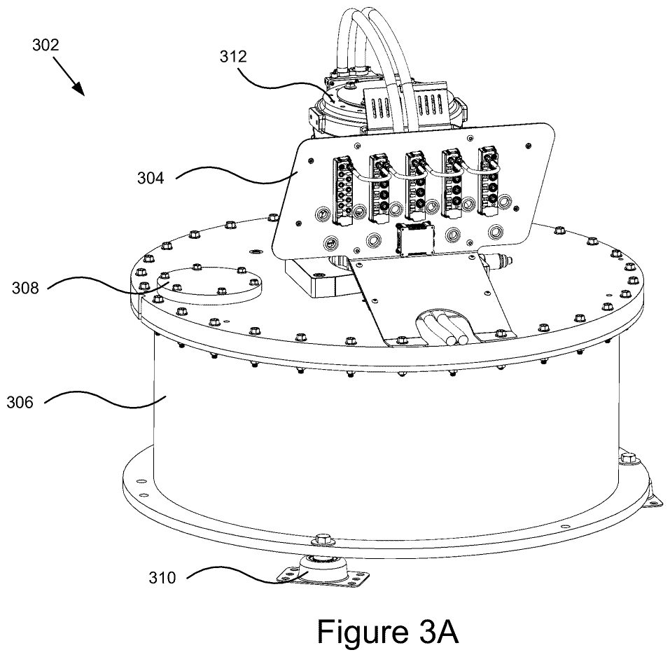

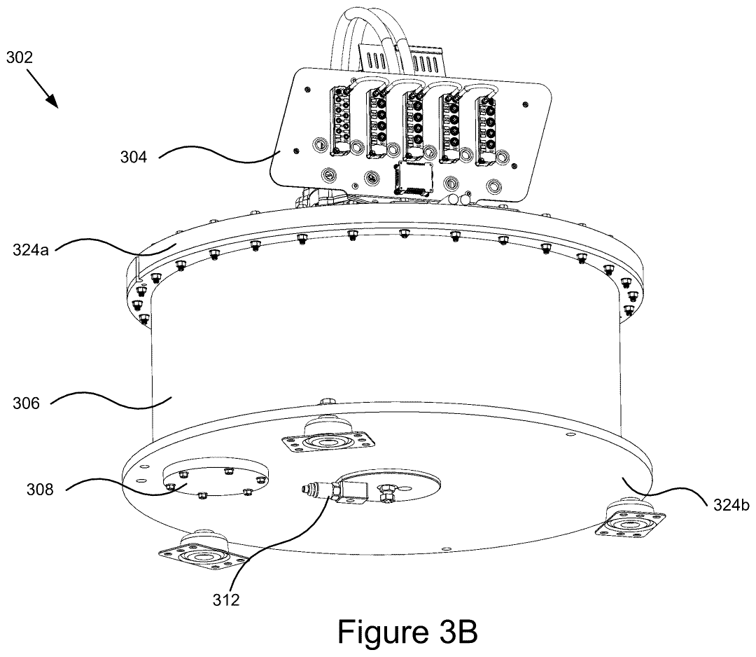

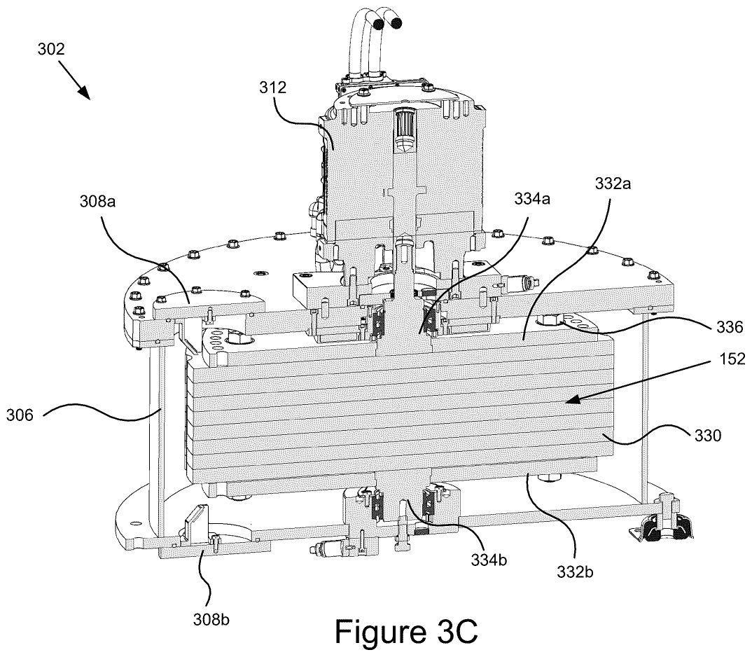

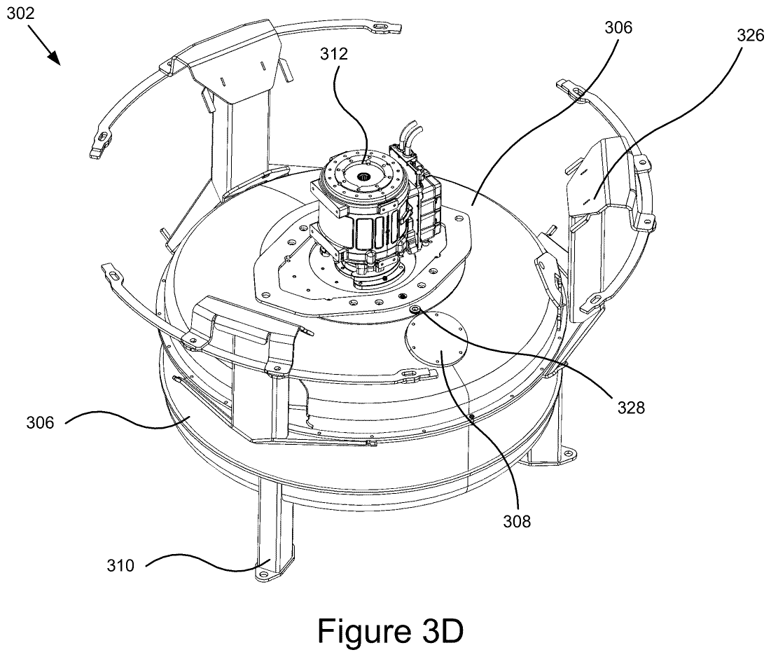

FIG. 2 illustrates an example method of balancing a flywheel 152, which may be performed within a flywheel enclosure 306 and/or after installation. Example elements of the flywheel 152 and enclosure are described throughout this description including in reference to FIGS. 3A-8. In some cases, the example balancing operations may use the example balancing extension slugs 652 described herein or other devices for balancing. In some implementations, the method may use the features and technologies described herein, although others are possible and contemplated. Similarly, the other features and technologies described herein may be used with other methods. Finally, it should be noted that the operations and sequence of the operations of the method of FIG. 2 are provided by way of example and that they may be varied without departing from the scope of this disclosure.

In some implementations, at 202, a multi-component flywheel 152 energy storage unit may be assembled. For example, a rotatable component of a flywheel 152 may be assembled, such as where it includes multiple separate components, such as one or more clamping plates 332, stacking plates 330, bolts 336, axles 334, or other components, though some or all of these components may be integrated together, omitted, or modified. In some implementations, the assembly may also include placing the rotatable flywheel 152 inside an enclosure 306, sealing the enclosure 306, and assembling inverters, motors 312, or other components. Additionally, multiple balancing steps of the flywheel 152 inside or outside of the enclosure 306 may be performed.

In some implementations, preparing the flywheel 152 may include machining holes or other receptacles 410 that receive balancing weights, which holes may be formed using a water jet or other device. The flywheel 152 and/or its receptacles may be marked based on their angles. For example, a top and/or bottom clamping plate 332 of a flywheel 152 may have a 0-degree position and/or other angles visibly marked (e.g., every 10-20 degrees). In some cases, reflective paint or tape may be applied to a component of the flywheel 152, such as an axle 334, clamping plate 332, stacking plate 330, bolt 336, or otherwise, which may be used by a laser to read flywheel 152 speed and/or position.

In some implementations, at 204, the flywheel 152 energy storage unit may be installed within its enclosure 306, transported, and/or installed at an installation location, which may be at a residence, business, in association with an energy utility company, or otherwise. In some implementations, the rotatable mass of the flywheel 152 may be installed after transport 308, or it may be transported assembled within an enclosure 306.

At 206, the flywheel 152 energy storage unit may be prepared for balancing. For instance, preparing it for balancing may include preparing a balancing configuration, sensors, and/or a balancing tool.

In some implementations, an off-the-shelf balancing tool, computer, or software may be used, which uses accelerometers 314 to calculate a balance of the flywheel 152 and/or amount by which the weight may be adjusted to balance the flywheel 152. In some cases, the balancing tool may include or couple with accelerometers 314 or other sensors to measure vibrations. The tool may be communicatively coupled with accelerometers 314 built into the FESS 302 or attached thereto. For instance, a first accelerometer 314 may be attached at a top plane (e.g., a top surface of an enclosure 306) and a second accelerometer 314 may be attached at a bottom plane (e.g., a bottom surface of the enclosure 306).

In some implementations, the flywheel 152 may be viewed or accessed via a port 308 on the top and/or bottom of the enclosure 306 to detect debris, anomalies (breaks, misalignments, etc.), or measure speed or vibrations. For instance, a laser measuring device or other optical or acoustic sensor may be positioned to measure the flywheel 152 position (in any axis), speed, vibration, or otherwise. In some cases, the access port 308 may be closed by a door 404, which may be a glass or clear acrylic window (as described elsewhere herein). For instance, an optical sensor or laser may be shined through the window to measure reflective tape or paint on a top surface or bottom surface of the flywheel 152.

In some cases, the window may include a mirror that allows an axle 334 or other components of the flywheel 152 to be viewed or measured (e.g., visually, using a laser, using a reflective or other surface, etc.).

Accordingly, where a laser or other sensor is being used to measure the velocity, position, or other attribute of the flywheel 152 in association with the balancing (e.g., with a balancing tool or other computing device), it may be set up to perform these functions. Where tape or paint is being used to assist in measurements and it is not already present, it may be added.

In some implementations, preparing the FESS 302 for balancing may include removing one or more of the doors 404 or windows enclosing the access ports 308, which may provide a clearer view or access to the flywheel 152. Where applicable, a vacuum may be released prior to opening the ports 308. The flywheel 152 may be balanced in a complete, partial, or non-vacuum.

In some implementations, at 208, the balance of the FESS 302 may be analyzed to determine the mass(es) and/or location(s) of the masses to be added (e.g., using balancing slugs 652) or removed (e.g., in some other implementations where the mass is being shaved, especially before placing it in an enclosure, if possible) from the flywheel 152 to improve its balance. For example, a balancing tool and/or software may calculate an amount and/or position of mass that is too great or too little to achieve balance. Various balancing tools, such as the Schenck Smart Balancer ™, may be used.

Although a number of different methods of analyzing the balance of a rotating system are possible and contemplated, one such example method is provided herein.

In some implementations, a flywheel 152 may be spun up to one or more defined speeds. In some cases, the technology may avoid selecting a resonance speed to use for balancing. When the flywheel 152 is at the measurement speed, measurements may be taken to determine acceleration, and a status may be calculated.

A test mass can be added in the software and to the flywheel 152. The test mass and position can be arbitrarily defined or adjusted depending on average balance or manufacturing tolerances at which a flywheel 152 is shipped. While the mass of a test weight may be defined in the software, in other cases, the software may recommend a test mass and/or position. For example, a 20-gram weight may be added at 90 degrees on a top clamping plate 332. The flywheel 152 may then be spun up again and measurements again taken. The flywheel 152 may be spun back down, and another test mass may be added to a second plate (e.g., bottom clamping plate 332 on a second plane) or the test mass may be moved, for example, to the second plate. The test mass may be positioned at the same angle or at a different angle (e.g., offset by 90 degrees). Once the test mass is installed/reinstalled, the flywheel 152 may be spun up, measured, and spun back down.

Once the acceleration, speed, position, and/or other data is collected from the balancing calibration runs (e.g., noted above), the balancing tool or software may calculate a position and/or mass to be added. For example, it may be determined that 36 grams should be added at 170 degrees on the top plate and 10 grams at 14 degrees on the bottom plate.

In some implementations, at 210, a balancing expansion slug 652 and/or set screw 654 configuration may be determined for the balancing mass(es). Where the weight system includes two or more parts, the calculated mass to be added may be divided based on available weights of these components. For example, a single expansion slug 652 and a single set screw 654 could be selected to create a first mass for a defined location on a bottom plate 332 while three expansion slugs 652 and five set screws 654 may be selected for a second defined location on a top plate 332 (e.g., filling multiple receptacles 410). In some instances, while brass expansion slugs 652 are described herein, various materials may be used for one or both of these components (e.g., brass, plastic, steel, lead, etc.) to achieve the respective mass. Additionally, during balancing, various masses may be added to multiple points, such as opposing points, to bring the axis of rotation (e.g., the balance) in line with the axle 334 of the flywheel 152. As noted below, several iterations of measurement and weight addition may be performed to bring the flywheel 152 to within tolerances.

In some implementations, at 212, one or more balancing expansion slugs 652 may be added to slug holder(s)/receptacle(s) 410 on the flywheel 152 (through the bottom and/or top balancing access ports 308). For instance, they may be added on a top plate 332a, a bottom plate 332b, or both, at defined locations. A technician may find the locations at which the slugs 652 should be added, for example, by rotating the flywheel 152 until an angle marker is visible through the access port(s) 308. Where each hole is not marked, the technician may count the receptacles 410 while rotating the flywheel 152 until the location is found (based on the calculations of the software or balancing tool).

The technician may insert the slug(s) 652 into the receptacle(s) 410. As noted elsewhere herein, a slug 652 may deform as it is inserted into a receptacle 410. In some cases, the slug 652 may be pressed, hammered, twisted, or otherwise inserted into the receptacle 410, which may be a cylinder, tapered cylinder, cylinder with a kerf, square, or have other shapes.

In some implementations, at 214, the technician may add one or more set screw(s) 654 to each balancing expansion slug 652 (through the bottom and/or top balancing access ports 308). Although other implementations are possible, a set screw 654 may be screwed into a center portion of the expansion slug 652. The set screw 654 may have a hex (e.g., for a standard Allen key) interface, though others are possible, that allows it to be twisted into threads on in the center or other portion of the expansion slug 652 (though it may be hammered, pressed, or otherwise inserted in other implementations). The set screw 654 may be inserted fully into a receptacle in the expansion slug 652 or only partially.

Where the set screw 654 is screwed into the expansion slug 652, it may cause bumps on the expansion slug 652 to press into the material (e.g., strengthened steel, etc.) in a receptacle 410 of a clamping plate 332 or other component of the flywheel 152. For example, bumps on the outside of a brass expansion slug 652 may be deformed as the set screw 654 is inserted (e.g., causing the deformable portions or arms of the expansion slug 652 to be pressed outward). As the brass bump(s) or ridge(s) are pressed outward and/or deformed, the deformation may cause them to be secured or improve securing them against the wall of the receptacle 410. Where the balancing receptacle 410 includes a kerf, texture, or other structure, this may further strengthen the hold. For example, a receptacle 410 may be cut using a water jet, which may create a rough surface and/or kerf that improve(s) the strength of the connection. These and other features are described in further detail elsewhere herein.

The balancing receptacles 410 in the flywheel 152 are illustrated herein as being near a peripheral edge of a clamping plate 332 of a flywheel 152, though other locations are possible and contemplated. Additionally, while the receptacles 410 are illustrated as being substantially cylindrical recesses in an axial direction, other shapes (oval, square, etc.), positions (on stacking plates 330, inward from an edge/near an axle 334, etc.), or orientations (circumferential, angled from axial, etc.) are possible and contemplated herein.

In some implementations, multiple set screws 654 may be added to a balancing expansion slug 652, for example, by placing them in different receivers in the slug 652 or by stacking them. As illustrated in examples herein, multiple set screws 654 may be stacked in an expansion slug 652 to add weight at a receptacle 410 in the flywheel 152. The additional set screws 654 may primarily add weight rather than cause expansion of the slug 652. Other or additional implementations are also possible, such as where weight (e.g., lead, etc.) is added to the slug 652 prior to the set screw 654 to add mass and then held in place using the set screw 654.

After adding the weights (e.g., using slugs 652 and screws 654), the balancing test may be repeated, such as where the flywheel 152 is spun up, measured, and spun down again. In some instances, this measurement/analysis may include adding mass or it may count the mass added in its calculations.

In some implementations, at 216, the port(s) 308 on the FESS 302 may be closed. For example, a door 404 may be attached over a port 308 in the flywheel enclosure 306. A seal 408 may be repositioned or left in place throughout the process. In some cases, where the door 404 includes a mirror assembly 406 (as noted elsewhere herein), the mirror assembly 406 may also be replaced or omitted. It should also be noted that, in some cases, the flywheel 152 balance may be measured in a vacuum, so the door 404 may be replaced, and the vacuum may be re-established prior to spinning up and measuring the balance of the flywheel 152, as noted above.

FIG. 3A illustrates an example flywheel 152 energy storage unit assembly 302 from a top-side view, FIG. 3B illustrates the example FESS assembly 302 from a bottom-up perspective view, and FIG. 3C illustrates an example FESS assembly 302 in a cross-sectional view. The example FESS assembly 302 may include an enclosure, isolating feet 310 supporting the enclosure, support 308 components on the enclosure 306, and access ports 308. Another example implementation of a FESS assembly 302 is illustrated in FIG. 3D.

As illustrated in the examples, an enclosure 306 may include a tub or cylinder in which a flywheel 152 may be placed. The enclosure 306 may have a rounded or angled outer edge, a bottom plate 324a or base (e.g., to which an accelerometer 314 may be coupled) and a top plate 324b or lid (e.g., to which another accelerometer 314 may be coupled). It should be noted that other components may be present, which are not visible. A bottom and/or bottom of the enclosure 306 may include perforations or ports 308 for access to the flywheel 152 for monitoring, maintenance, and/or balancing. As illustrated herein, around the ports 308/perforations, there may also be a groove that holds a seal 408, which provides a seal against the door(s) 404 closing the port(s) 308, though these seals 408 may alternatively be in the door(s) 404 to reduce manufacturing complexity of the enclosure 306. Also, bolt holes may also be added to allow the door to be coupled to the enclosure 306, though they may also or alternatively be coupled using clamps or other devices that may be sealed, threaded, or otherwise.

The FESS 302 components or support 308 components may include a motor 312 and/or generator, magnetic couplings, bearings, magnetic lift components 414, computing devices, network connections, sensors, vacuum components, etc.

The cross-section example of FIG. 3C illustrates a flywheel 152 inside an enclosure 306 along with various other components, though many other configurations and implementations are possible and contemplated herein.

As shown in the depicted example of FIG. 3C, the flywheel 152 may include multiple components, such as a top clamping plate 332, a bottom clamping plate 332, stacking plates 330 providing configurable mass, a top axle 334, a bottom axle 334, bolts 336, and other components. The top and bottom clamping plates 332a and 332b may couple with the axle(s) 334a and 334b, respectively, and may be drawn together via bolts 336 to compress and/or hold the stacking plates 330 in their orientation and couple the stacking plates(s) 330 with the axle(s) 334 (e.g., via the clamping plate(s) 332). While a multi-part configuration is beneficial for manufacturing, it may exacerbate difficulty in balancing and/or may allow small shifts in balance (e.g., during transport 308, etc.).

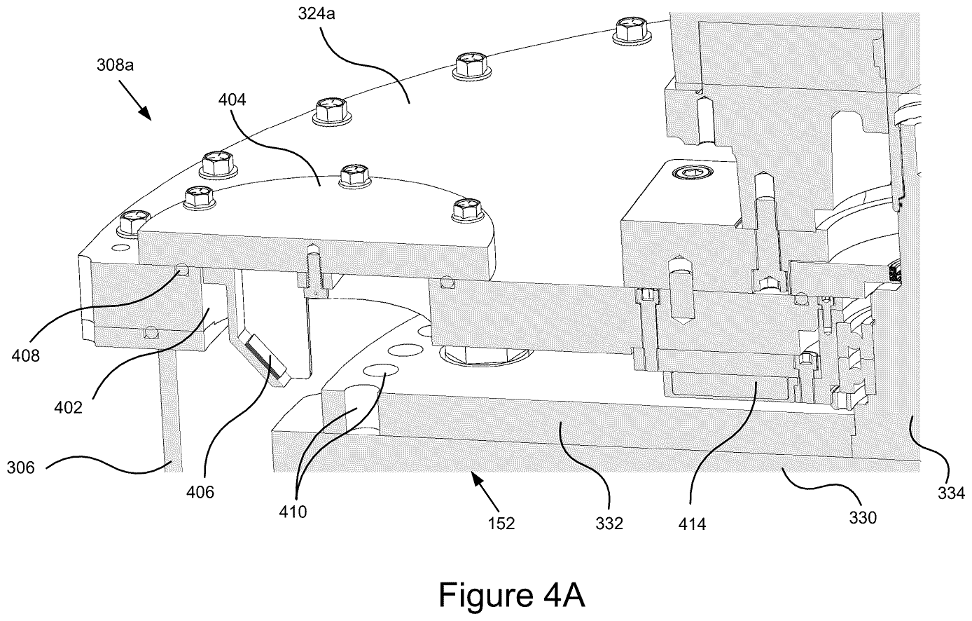

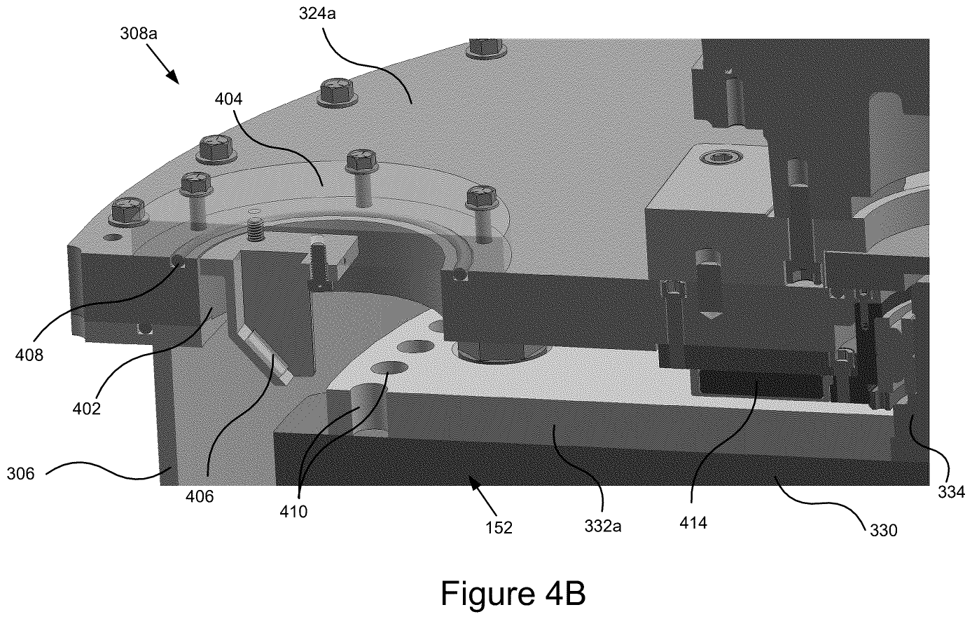

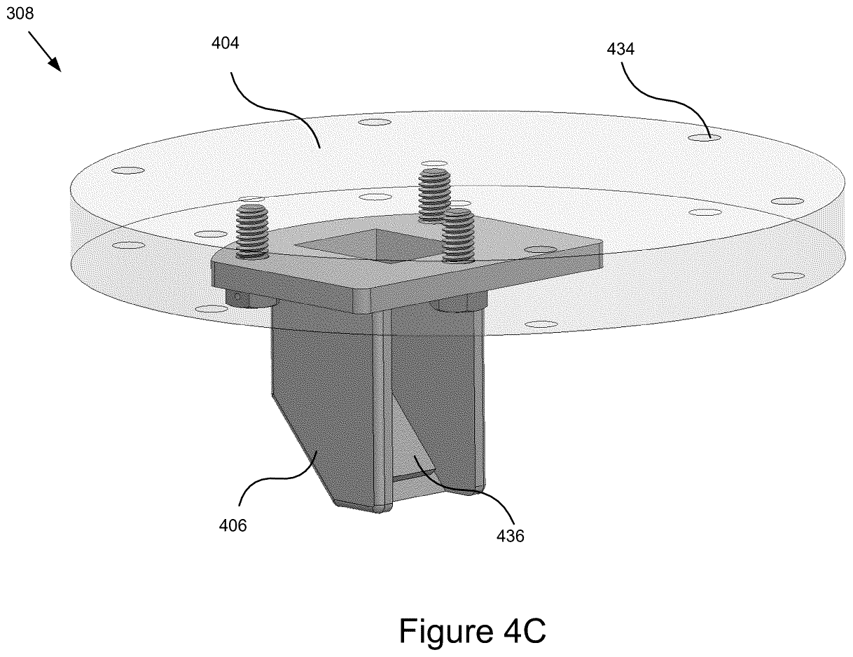

The example of FIG. 3C also shows a motor 312, magnetic lift components 414 (e.g., as illustrated in the detail example of FIG. 4A), sealing components, bearings, etc. The example also shows a top balancing access port 308 located proximate to/above an outer edge (e.g., where slug receptacles 410 are located) of the flywheel 152 and in the top of the enclosure 306. A bottom balancing access port 308 is similarly shown in the bottom of the enclosure 306. Example implementations and features of the top and bottom balancing access ports 308a and 308b are shown and described below. It should be noted that although these ports 308 are shown outboard, on the top and bottom, and in a circular configuration, others are possible and contemplated, such as where one or more of the ports 308 are positioned on a side wall, rectangular in shape, etc. For example, a bottom access port 308b may be positioned on a side wall of the enclosure 306 to provide access, depending on mounting location.

FIG. 3D illustrates another example implementation of a FESS assembly 302. As illustrated, the enclosure 306 may consist of a dome shape, such as a top dome, bottom dome, and cylindrical center section. A motor 312 may be coupled at a top dome of the enclosure 306. In some implementations, in addition to or in place of support feet 310 supporting the enclosure 306, the enclosure may be hung by suspension arm(s) 324.

As shown in the example, a port 308 may be located in the top dome of the enclosure 306. As the dome shape is at an angle, the port 308 may be at an angle. It should be noted that although a single port 308 is shown in FIG. 3D, the port(s) 308 may be located in the top dome and/or bottom dome. In some cases, two, three, or more ports 308 may be located around the top and/or bottom domes at different angles, which makes accessing different receptacles 410 easier.

In some implementations, an access plug 328 may included adjacent to a port 308. The access plug 328 may be removed from a hole or socket to provide direct access to a receptacle 410. For instance, a balancing slug 652 may be inserted through the access plug 328 and viewed, tightened, or handled via the port 308.

FIGS. 4A and 4B illustrate cross section views of an example top balancing access port 308. FIG. 4B illustrates the example implementation of FIG. 4A in grayscale to illustrate that a door 404 may be transparent. In the depicted example, the port 308 may include a perforation 402 through the top surface 324a of the enclosure 306, which perforation 402 may be circular in shape, and it may be 5-8 inches (e.g., 5.5 inches) in diameter to allow a tool and/or hand to pass through. The perforation 402 may include a groove on the top plate or door for receiving an O-ring seal 408. Bolts or other fastening devices may hold a door 404 to the top plate 324a and compress the seal 408. The access port 308 may be positioned to allow access to the slug receptacle(s) 410.

In the depicted examples, a door 404 may be transparent (e.g., including or as a window) may be used and may be clear/transparent, for example, constructed of clear acrylic, which allows the flywheel 152 to be viewed and/or measurements to be taken. In some implementations, a mirror assembly 406 may also be coupled or integrated with an interior portion of the door 404 to allow viewing and/or measurement of other aspects of the flywheel 152, such as the axle 334, bearings, seals, etc. In some cases, a mirror may be positioned to be at the edge of the top clamping plate 332, and it may allow a technician to adjust the relative position between the top clamping plate 332 and a magnetic lift component 414, though other operations are also possible.

As illustrated in the example of FIG. 4A, receptacles 410 may be located near a periphery (or at another location) of the flywheel 152, such as in a clamping plate 332 or, potentially, a stacking plate 330. The port 308 may be located above or adjacent to the receptacles 410 to allow access to the receptacles.

FIG. 4C illustrates an example door 404/window and mirror assembly 406 for a balancing access port 308. As shown in the example, the door 404 may include a circular plate of clear acrylic, though other materials are possible. For example, the door's plate may be seven to eight inches in diameter to sufficiently cover a perforation 402 while also allowing bolt holes 434 to bolt the door 404 to the enclosure 306 at the perforation 402 and a seal 408 to seal the port 308. The thickness of the door 404 may depend on the strength of the material selected and the size of the port 308. For instance, in the depicted example, the door 404 is three-quarter inches thick, though other implementations are possible and contemplated.

In some implementations, a mirror assembly 406 may be mounted to an interior surface of the door 404 (e.g., window) plate. The mirror assembly 406 may extend downward and hold a mirror 436 at a position and angle to allow monitoring, measurements, calibration, flaw or error detection, etc. The mirror assembly 406 may be bolted, glued, or otherwise attached on the inside of the door 404 plate, though it may be formed together and/or accessible from an outside of the enclosure 306. In the depicted example, the mirror assembly 406 is bolted to the door 404 plate. The bolt holes 434 may not extend through the door 404 plate to avoid having to seal them. Additionally, in some instances, the bolts at the bolt holes 434 may include wire holes to allow them to be locked in position using a wire or pin, or they may include other locking mechanisms, which prevents the bolts from backing out during vibration and creating debris or a projectile inside the enclosure 306.

The clear door 404/window and/or mirror 436 may allow monitoring of various components, measurements (e.g., using a laser) for balancing or other operations.

The illustrated example balancing access port door 404 may be used on the bottom and/or bottom balancing access port 308. In some instances, the sizes, shapes, positions, etc., of the doors 404/windows and/or mirror assemblies 406 may be the same or different between the top and bottom to accommodate for different geometries or needs of these sections, depending on the implementation.

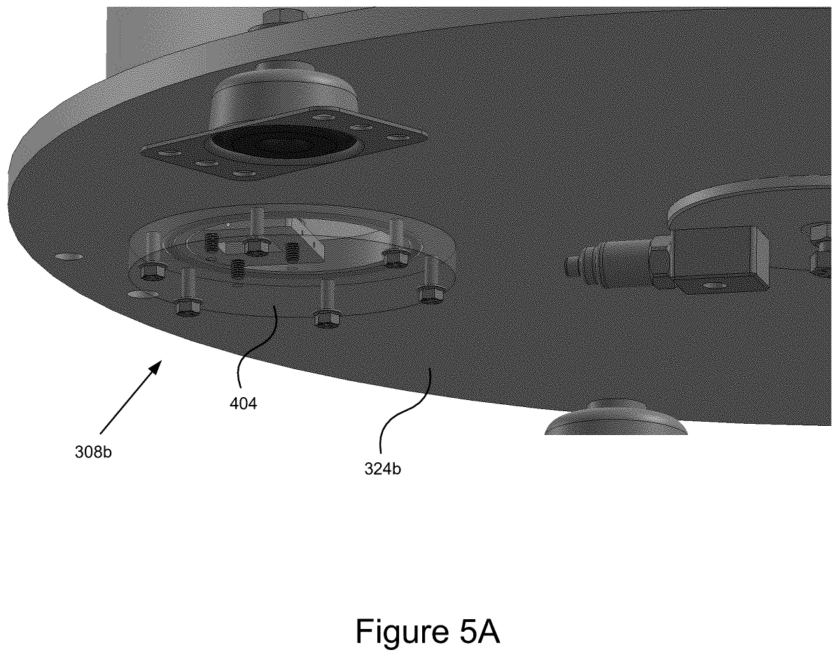

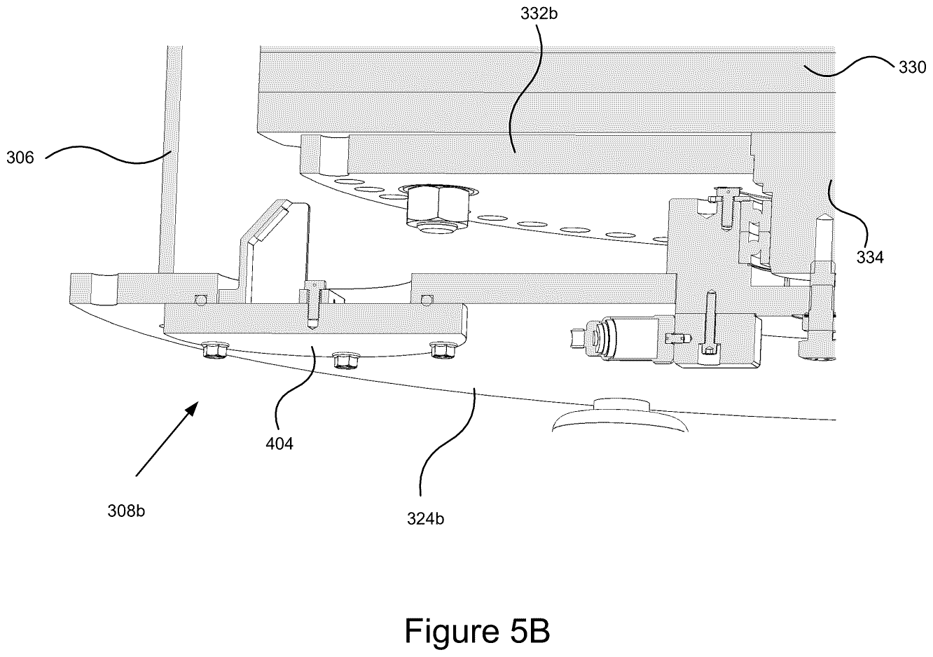

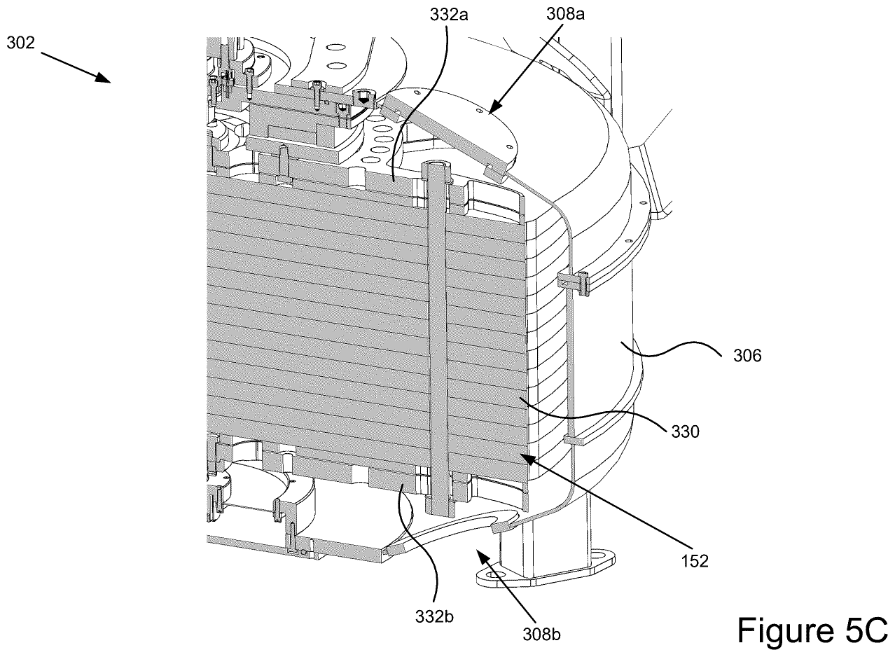

FIG. 5A illustrates an example bottom balancing access port 308b with a door 404 in a bottom plate or base 324b of an enclosure 306. FIG. 5A is shown in a grayscale image to illustrate that the door 404 may be transparent to expose the interior of the enclosure 306. FIG. 5B illustrates a cross section of the example bottom balancing port 308b. As illustrated, these components may have the same or similar configuration to the top balancing access port 308a and door 404.

FIG. 5C illustrates a cross-sectional view of another example FESS 302. In the depicted example, a top access port 308a and a bottom access port 308b are shown in the top and bottom domes of the enclosure 306. In the depicted example, the clamping plates 332a and 332b may have a snowflake or other shape, and the receptacles 410 are positioned closer to an axle, though this position may be varied depending on impact or precision of changes due to weights, or other factors. Other configurations, such as spacing plates or stacking plates 330 of a flywheel 152 may have various configurations, as noted elsewhere herein.

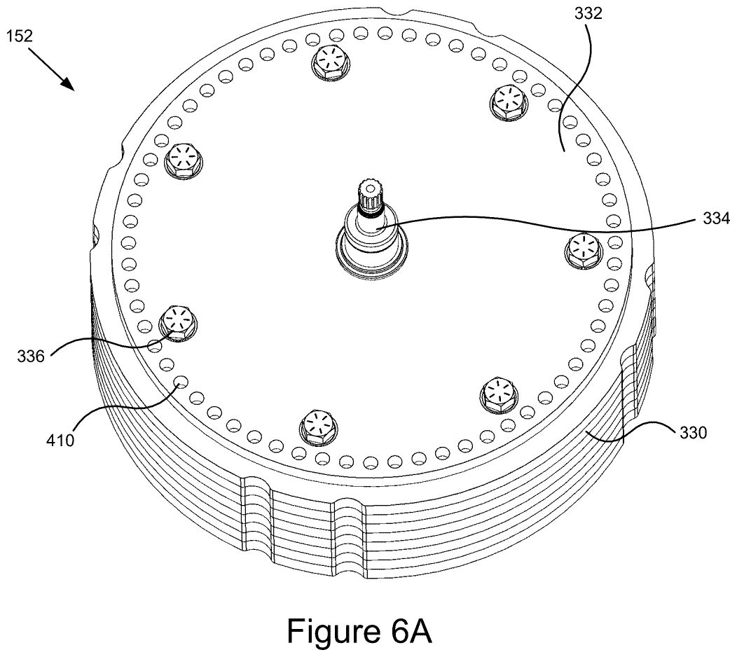

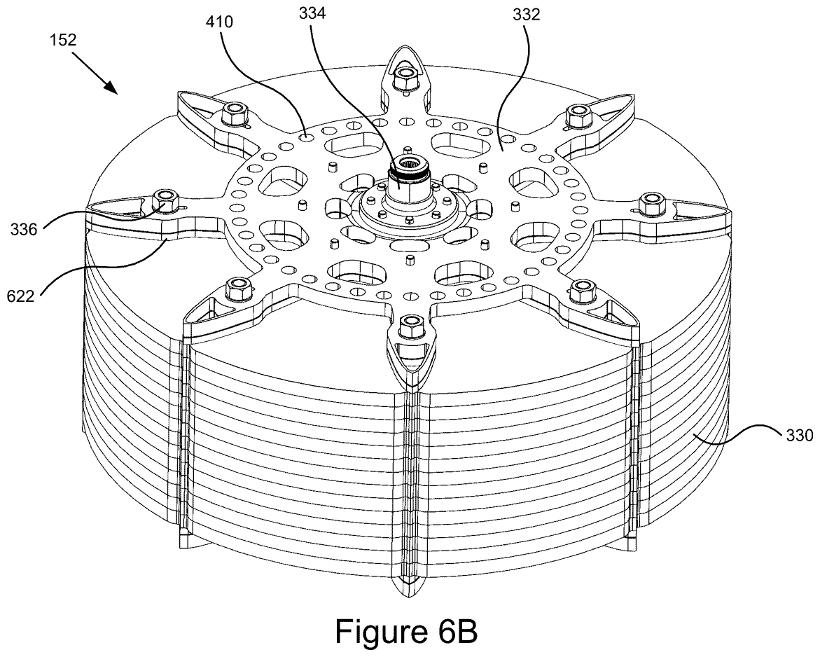

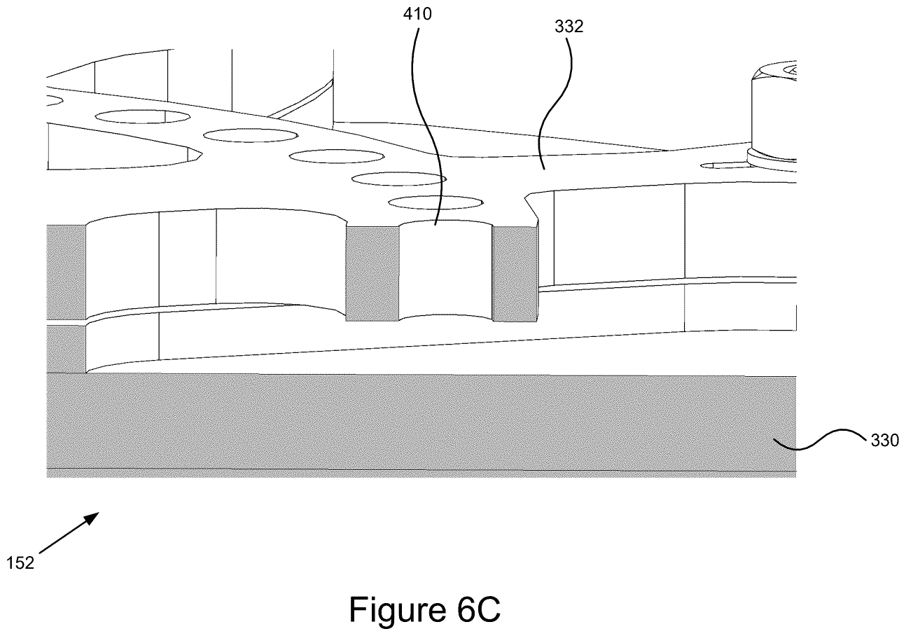

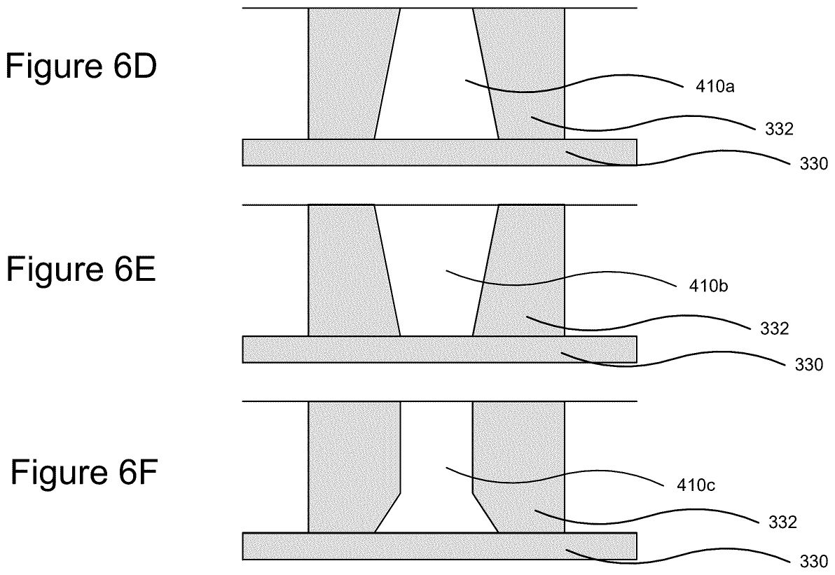

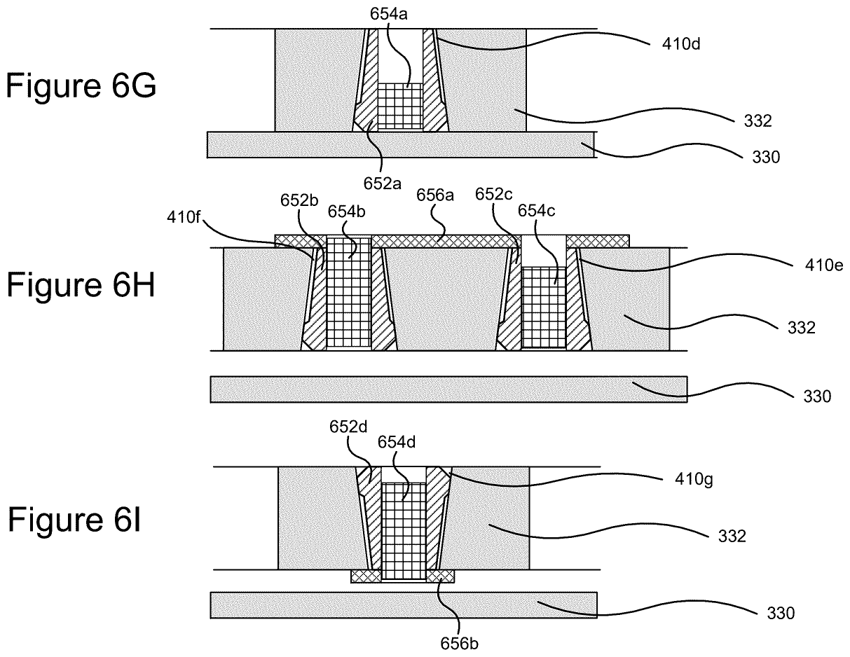

FIGS. 6A and 6B illustrate example implementations of a flywheel 152. In the examples, a top and/or bottom clamping plate 332 may support, hold together, or attach the stacking plates 330 together and/or to the axle(s) 334. For example, clamping bolts 336 may pull a top clamping plate 332 toward a bottom clamping plate 332 (only a single clamping plate 332 is shown, though they may be the same or different configurations), which applies friction and compression to the stacking plates 330 and locks them in the orientation. In some implementations, the bolts 336 may extend through perforations in the plates 332 or 330.

As illustrated in the example of FIG. 6A, the balancing slug receptacle(s) 410 may be placed around the edge of the clamping plate 332. As illustrated in the example of FIG. 6B, the balancing slug receptacle(s) 410 may be placed closer to an axle 334 in the clamping plate 332, though this receptacle ring or area may be moved inward or outward depending on the implementation.

The receptacles 410 may be cylindrical perforations in the clamping plate(s) 332, for example, in an axial direction and around a periphery. Other implementations may include placing them in stacking plates 330, placing them farther from the peripheral edge, or otherwise. Additionally, various quantities of receptacles 410 may be used, they may be placed irregularly, or otherwise. Multiple receptacles 410 may be used in the receptacles 410 on the top and/or bottom of the flywheel 152 to fine tune the balance in multiple axes.

As noted elsewhere herein, the receptacles 410 may have various shapes or positions. For example, the receptacles 410 may be cut using a water jet (or machined, drilled, laser cut, etc.), which may cause a rough edge and/or kerf. Though not necessary, a kerf, bevel, or other shape may be positioned to interact with bump(s) or other shapes on the balancing expansion slug 652, thereby further strengthening the hold. Other shapes, bevels, tapers, etc., may be used.

In some implementations, using paint, machining, or otherwise, angles may be marked on the clamping plates 332 or otherwise, to assist in balancing. In some cases, reflective paint or tape may be placed on the flywheel 152 to improve automated measurement of velocity or position, as noted elsewhere herein.

As illustrated in FIG. 6A, a flywheel 152 may include a plurality of stacking plates 330, which are sandwiched between clamping plates 332. In the depicted example, the stacking plates 330 and the clamping plates 332 are substantially circular. A stacking plate may be a flat plate with holes for the bolts 336, and they may or may not include perforations for axles 334 or other components. The clamping plate 332 may include a perforation or connection point for an axle 334, which allows the clamping plate 332 to impart rotational force via the axle 334 (e.g., to a motor 312). The clamping plate 332 may include perforations or other structures for receiving bolts 336. The clamping plate 332 may include a ring of receptacles 410 for receiving balancing slugs 652. It should be noted that although certain example configurations of flywheels 152 are shown, solid flywheels, flywheels of different shapes, flywheels with or without clamping plates, or other configurations may be used with the balancing slugs 652 or other technologies described herein.

FIG. 6B illustrates another example configuration of a flywheel 152. The example flywheel of FIG. 6B also includes stacking plates 330 and clamping plates 332. In the depicted example, the snowflake shaped clamping plate 332 include a ring of holes or receptacles 410 that receive weighted slugs 652. These receptacles 410 may be placed in the ring nearer the center or further out radially to change how much impact a single slug 652 has on the overall balance of the flywheel 152. A slug 652 may be or include a screw, adhesive-based, resin-based, and/or friction-based weight that affects the balance in one or more axes of the flywheel 152. Various weights of slugs 652 may be used. In some implementations, a slug 652 may have an outer friction-based housing and receive threaded weights into the center thereby increasing the friction while also changing the weight depending on the size or weight of the threaded weight. For instance, a tapered portion of the threaded weight or slug 652 may cause it to expand within the receptacle 410, thereby increasing the stability and adjustability of the balancing slug 652.

As illustrated in the example, a snowflake clamping plate 332 may have eight arms, which match bolt hole locations of the stacking plates 330. Each arm may have angle/thickness that may remain static or taper along its length. The relative size and taper of the arm depend on the configuration of the stacking plates 330. For instance, for an example forty-two-inch diameter stacking plate, the snowflake arms may be configured as shown. By using finite element analysis, it may be determined how the stacking plates 330 stretch under centrifugal load. Similarly, various sizes or shapes of arms or other structures of the snowflake clamping plate 332 may be analyzed to determine how far they stretch when under centrifugal load. In the depicted example, the stretch at the clamping bolt hole locations of the snowflake clamping plate 332 is matched to the stretch of the bolt hole location of the stacking plates 330. Accordingly, by using this improved structure, sheer force on/by the clamping bolts 336 is reduced or eliminated, thereby reducing stress and failure points of the system.

In some implementations, a spacer plate 622 may be disposed between a stacking plate 330 and a clamping plate 332. The spacer plate 622 may have a similar configuration to the clamping plate 332, and it may be configured to accommodate bolt heads, nuts, or washers. For instance, the spacer plate 622 may include a space and/or threads under the clamping plate 332 to receive a nut, bolt head, or washer. In some implementations, the spacer plate 622 may be omitted, and bolts may extend downward (instead of upward, or may be integrated), so no spacer plate is needed to accommodate bolt heads.

FIG. 6B illustrates a cross-sectional view of a receptacle 410 in a clamping plate 332. As shown in the example, the receptacle 410 may be cylindrical in shape. Depending on the implementation, the receptacle 410 may have various shapes or features. The receptacle may include a full or partial hole in the flywheel 152, such as in a clamping plate 332. The hole may be cut by machining, laser, or water jet, for example, which may allow for various shapes or configurations of the receptacles, as noted below. For example, a hole cut with a water jet may cause the hole to expand outward (e.g., not in a perfect cylinder) on the opposite side from which twater jetjet is placed. Accordingly, because a wider flare being positioned inward increases the security of the fit of the balancing slug 652 (e.g., when it is expanded outward), the receptacle 410 hole may be cut from an outer edge, as noted below. In some cases, the cylindrical shape of the hole may be enforced, or a flared or beveled cut of the hole may be caused by using a multi-axis (e.g., 5 axis) waterjet, which may be angled to shape the cut.

Additionally, as shown in the example of FIG. 6C, in some implementations, a space may exist under a clamping plate 332. In order to further secure a balancing slug 652, a washer, nut, or other structure may be used to further reinforce the static position of the balancing slug 652.

FIGS. 6D, 6E, and 6F illustrate other examples of receptacles 410, which may be cut in a clamping plate 332 or other structure of a flywheel 152. While various configurations and sizes may be used, the example shapes of the figures may be exaggerated for illustration purposes. As shown in FIG. 6D, a taper of the receptacle 410a in a clamping plate 332 may be positioned so that it is wider closer to a stacking plate 330. As shown in FIG. 6E, a taper of the receptacle 410b in a clamping plate 332 may be positioned so that it is wider farther to a stacking plate 330. As shown in FIG. 6F, a taper of the receptacle 410c in a clamping plate 332 may be positioned so that it is beveled closer to a stacking plate 330. These are three example implementations, although others are possible and contemplated. It should also be noted that although no space is shown between the clamping plate 332 and the stacking plate 330, the stacking plate 330 and/or a spacer plate 622 may be placed to provide a recess or space below some or all of the receptacles 410. Such a space may allow a bolt, washer, or threaded washer, etc., to be placed at the receptacle 410 to couple with a balancing slug 652 thereby further improving security of placement of the balancing slug 652.

FIGS. 6G, 6H, and 6I are cross-sectional views illustrating various example configurations of receptacles 410 in association with balancing slugs 652. It should be noted that although certain configurations, components, and examples are shown, these are an example subset of possible options but are illustrative of some ways in which the technology may be used. While stacking plates 330 and clamping plates 332 are shown, other flywheels are possible and contemplated herein.

FIG. 6G illustrates a cross section showing a clamping plate 332 and stacking plate 330. In the clamping plate 332, a receptacle 410d is shown that is tapered with a flared end toward the stacking plate 330. As noted elsewhere herein, the receptacle 410d may be cylindrical, tapered in the other direction, have rough edges, be threaded, or have other configurations. In the example, a balancing slug 652a is inserted into the receptacle 410d. When the set screw 654a is inserted into the balancing slug 652a, it presses the sides out and into the sides of the receptacle 410d to hold it in place. Various sizes of set screws 654 may be used to change the fit and/or mass of the assembly.

FIG. 6H illustrates a cross section showing a clamping plate 332 and stacking plate 330. In the clamping plate 332, two adjacent receptacles 410f and 410e are shown with a flared taper toward the stacking plate 330. Also, in the example, a space (e.g., due to a spacing plate 622 or due to a recess in a stacking plate 330) is illustrated between the stacking plate 330 and the clamping plate 332, but other configurations are possible. As shown in the depicted example, a washer 656 may be placed over a receptacle 410. While a washer 656 may be placed over a single receptacle 410, in some implementations, the washer 656a may span multiple receptacles 410f and 410e, as illustrated.

Various configuration of a washer 656 may be used with a balancing slug 652 and set screw 654. The washer 656 may be threaded to interact with a set screw 654 or other fastener, and/or the washer 656 may be held in place using an additional nut or bolt head (not shown in the example) that holds the washer 656 in place. The washer 656 may serve various functions, such as adding additional mass and/or holding a slug 652 in place (e.g., for example, to assist with an opposite taper of a receptacle 410).

Like FIG. 6H, FIG. 6I illustrates a cross-sectional view in which a receptacle 410g is in a clamping plate 332, and a space is shown between the clamping plate 332 and the stacking plate 330. In the example of FIG. 6I, the receptacle 410g is tapered, so that the flare is facing outward (e.g., away from a stacking plate 330). Additionally, as depicted in the example, a washer 656b is shown on a side of the receptacle 410g opposing the flare, which may further secure the balancing slug 652d (e.g., via a bolt or set screw 654d).

It should be noted that although the examples shown herein illustrate a washer 656 at a side of a receptacle 410 opposing a flare, the flare may be omitted, the washer may be placed on the same side as the flare, or the washer may be omitted. Similarly, the set screw 654 may include a head, multiple set screws 654 may be used, a separate bolt may be used, and/or a set screw 654 and a bolt may both be used.

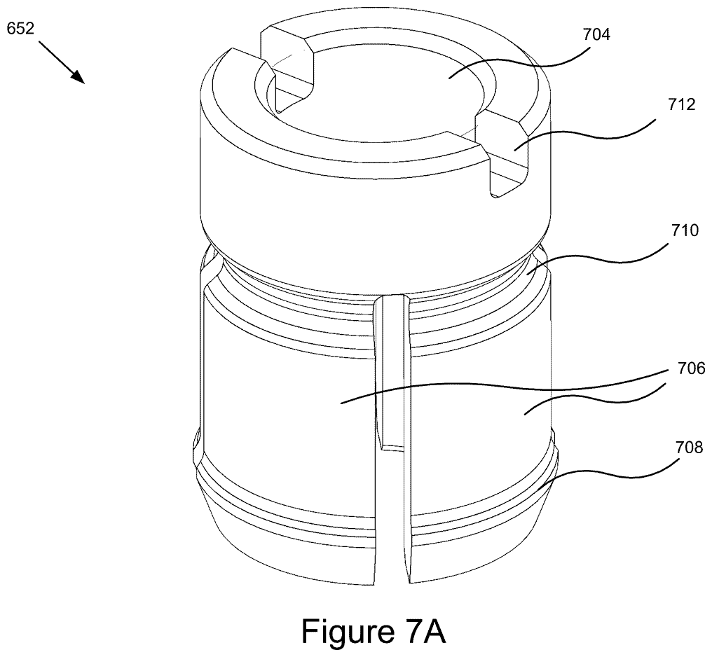

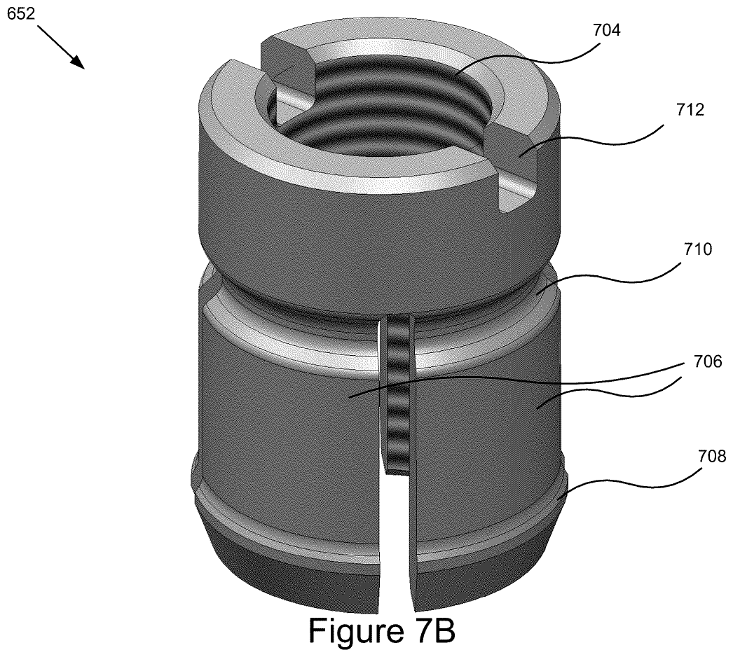

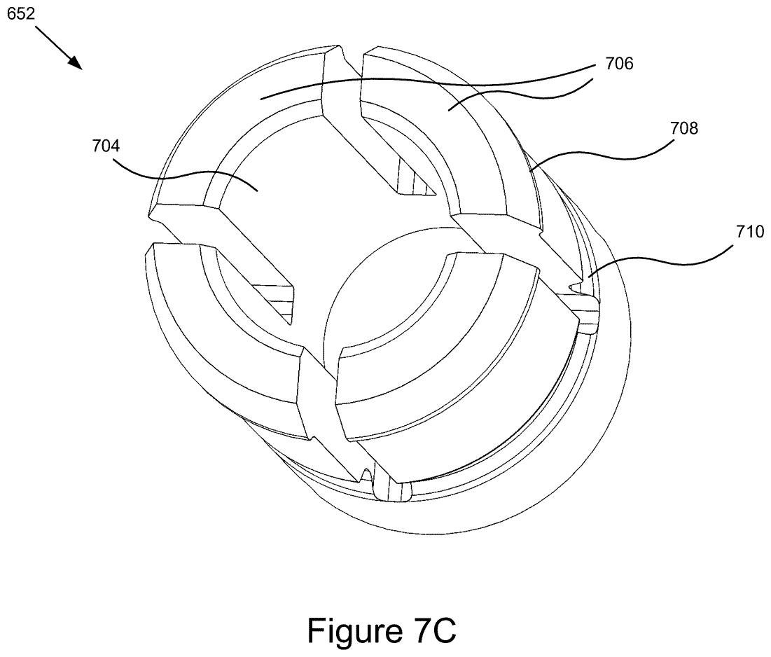

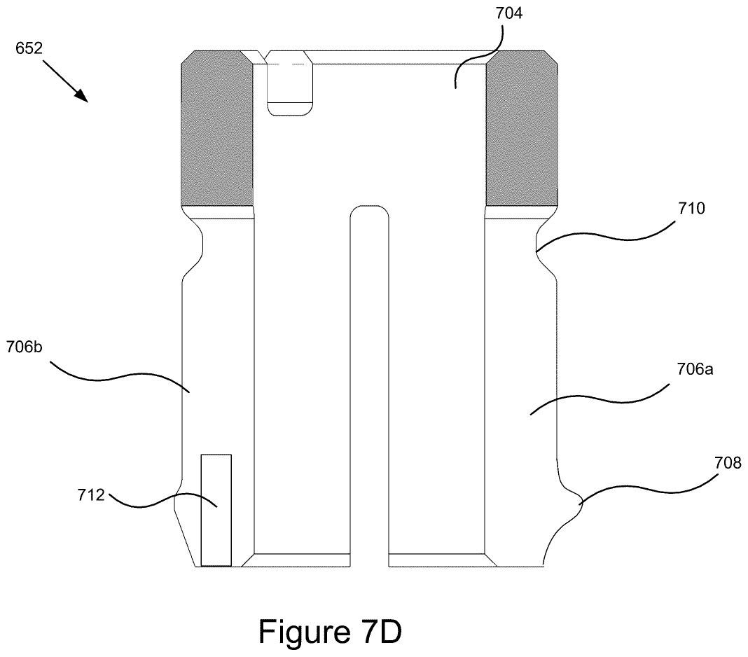

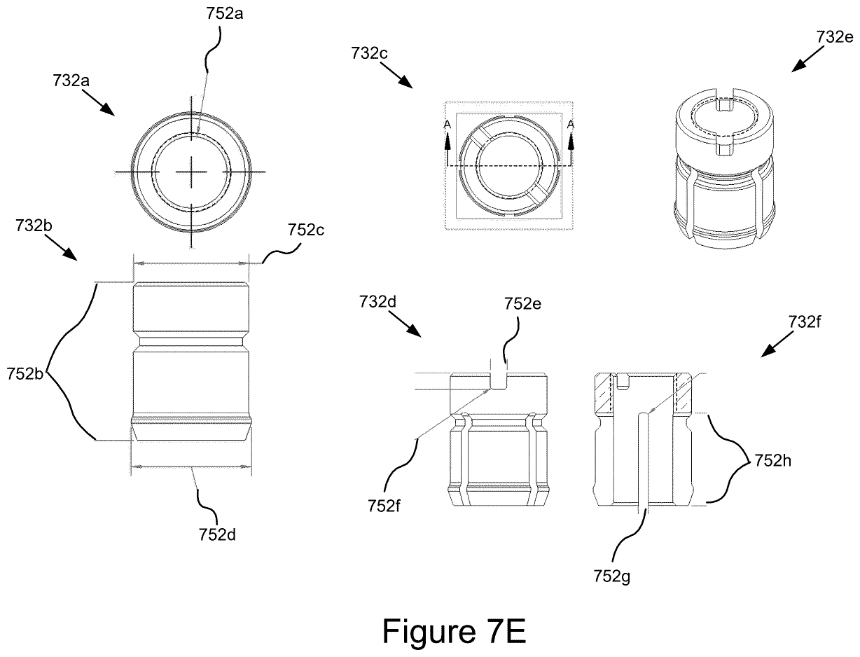

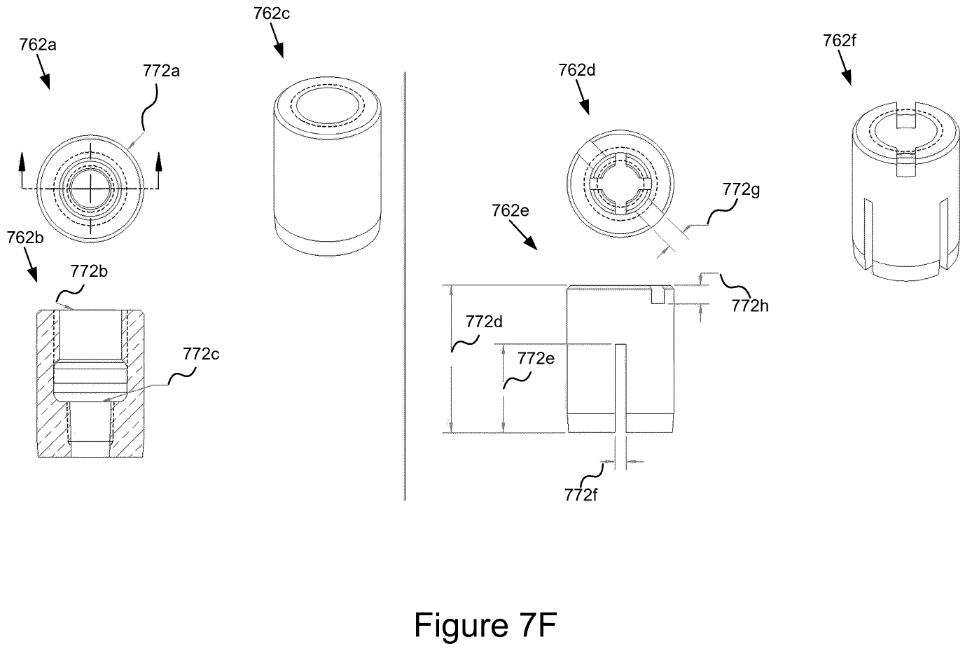

FIGS. 7A, 7B, and 7C illustrate various views of an example balancing expansion slug 652. As shown, the shape of the balancing slug 652 may match or nearly match (depending on whether it is in an expanded state or not, for example) the shape of the receptacle 410, although it may be shorter or longer than the receptacle 410 depending on weight or other requirements. For example, as shown, the slug 652 may have a substantially cylindrical shape including a center channel 704 or perforation into which one or more set screws 654 or slugs 652 may be inserted. As shown in FIG. 7B, the center channel 704 may be threaded to receive the set screw(s) 654. In some instances, the channel 704 may be machined as a straight cylinder but may flex inward when inserted into the receptacle 410, as noted below. Accordingly, the channel 704 and thread(s) may be machined with straight sides but, when they flex inward, they may create the taper that receives the set screw 654 thereby causing the arms/fingers 706 to be pushed out, as noted elsewhere herein.

In other instances, a channel 704 may be machined with a taper so that, when the balancing slug 652 is in a relaxed, detached position, the radially outside surface of fingers 706 are a straight or substantially cylindrical configuration. Thus, when a set screw 654 is inserted into the channel 704, it may push the fingers 706 outward.

The slug 652 may include one or more (e.g., 4) fingers/arms 706 that flex when inserted into the slug receptacle 410 and/or when a set screw 654 is inserted into the channel 704. The arms 706 may be created by cuts (e.g., using a bandsaw, etc.) around the slug 652. The arms 706 may be inserted into the receptacle 410 first and, when they are inserted, the arms 706 may flex inwards, which creates a taper to the center channel 704. For example, the arms 706 may include a ridge 708 or bumps extending around a circumference of the slug 652. The ridge 708 may be wider than the remainder of the arms 706 or even the entirety of the slug 652, so that when the slug 652 is inserted, it pushes/flexes the arms inward, though other implementations are possible. Although the example slugs 652 are shown with four cuts (and therefore four fingers 706), other quantities, such as three, five, six, or otherwise may be used.

In some implementations, the slug 652 may include a flex channel 710, which may be a section of thinner material at the edge/top (e.g., at the edge of the cuts) of the arms 706 that allows the arms 706 to flex more easily. The depth or width of the flex channel 710 may be adjusted depending on the material of the slug 652 and the desired tension or resilience of the arms 706 (e.g., based on the elastic modulus of the material, etc.).

In some cases, an end of the slug 652 may include one or more notches 712 or other structures that allow the slug 652 to be twisted or pulled during insertion or removal. In some cases, the notches 712 may be combined with the cuts on the arms 706 or may otherwise be modified.

In some implementations, the slug 652 may be constructed from brass, though other materials, such as steel, plastic, lead, etc., may be used depending on the desired weight or other parameters. Brass may be beneficial as it allows some compression or deformation of the ridge 708 when a set screw 654 is inserted thereby improving a holding strength (especially when a wall of a receptacle 410 is rough due to a water jet cut). This same property may be true of other materials as well, but the ridge 708 and flex channel 710 may be varied in size or configuration to match the material or desired deformation. Similarly, the thickness or size of the slug 652 may be varied to adjust its mass. Additionally, while other implementations are possible, brass is beneficial as it allows flex (e.g., unlike aluminum or steel) while avoiding creep or loss of strength (e.g., like plastic). For instance, because the receptacle 410 in the clamping plate 332 may be constructed of hardened or high strength steel (and it applies a very high force nearly entirely in the radial direction), the flywheel presents a different situation than where an anchor is inserted into or through a soft material. Accordingly, using a softer or more deformable material for the balancing slug 652 than the receptacle 410 is beneficial for the strength of the flywheel 152 and security of the balancing slug 652.

The example slugs 652 described and illustrated herein provide significant advantages in the context of a flywheel 152 because they allow various masses to be added while reducing the risk that the mass/weight will become detached at high RPMs.

FIG. 7D is a cross-sectional view of an example balancing slug 652. While threads are not shown, in some implementations, the channel 704 may be threaded. A flex channel 710 is shown on an arm/finger 706 and extending around the periphery of the slug 652. In the depicted example of 7D, a sharper, more protruded ridge 708 is shown on the right side of the illustration. While this particular shape may vary, it is illustrative of how a thinner and/or sharper point of the ridge 708 may be used, which may increase the amount by which it deforms into a receptacle 410. As another example variation, the left side of FIG. 7D shows an undercut 722 in a finger 706b, which undercut 722 may further improve flex of the ridge 708. While the undercut is illustrated as a channel between an outer and inner face of the balancing slug 652, it may be solely located on the inside of the channel 704. Additionally, or alternatively, the material may otherwise be thinned or modified using a bevel, taper, notch, or other structure to further facilitate deformation of the slug 652 and/or ridge 708. Similarly, the ridge 708 may consist of multiple ridges, bumps, or other shapes.

While a ridge 708 may be omitted in some implementations, as shown in the cross-section of FIG. 7D, this configuration improves manufacturability of the balancing slug 652. For instance, a channel 704 may be machined and threaded in a straight cylinder while the ridge(s) 708 may extend to be wider than a receptacle 410 or entrance thereof. Accordingly, when the slug 652 is inserted into a receptacle 410, a ridge 708 may push a finger 706 inward toward the channel 704. Then, when a set screw 654, bolt, or other structure is inserted into the channel 704, it may cause the finger(s) 706 to push back outward. In some implementations, when the fingers 706 are pushed outward, the ridge(s) 706 may press into the external material. Where the ridges 706 are made of softer material (e.g., brass), they may deform and bite into the receptacle 410. Where the receptacle 410 is cut using a water jet, its inner surface may be somewhat rough, which further improves the bite of the ridge, such as where a brass ridge deforms into the rough surface.

FIG. 7E illustrates various drawings or drawings and measurements of an example balancing expansion slug 652/plug. The drawing 732a illustrates a top-down view, 732b illustrates a side view, 732c illustrates a top-down view, 732d illustrates a side view, and 732f illustrates a cross-sectional view of example balancing expansion slugs 652. In the depicted example, the slug 652 may have a length of 1 inch, as indicated in measurement 752b, a width of 0.73 inches, as indicated in measurement 752c, a center channel of 0.453 inches, as indicated in measurement 752a, etc., which leads to a total mass of approximately 30 grams, though these sizes, weights, features, and configurations are provided solely by way of example and several others are possible and contemplated. In the depicted example, the ridges are slightly wider with an illustrated example measurement 752d of 0.76 inches.

The slot width may be 0.125 or 0.25 inches, as indicated in measurement 752e and a depth of 0.125 or 0.25 inches, as indicated in measurement 752f. A width of a finger slot may be 0.075 to 0.150 inches, as indicated in measurement 752g, and a height of 0.6 to 08 inches, as indicated in measurement 752h. While no measurements are indicated in view 732c or 732e, these views include examples lot and offset configurations.

FIG. 7F illustrates various drawings and measurements of example implementations of the balancing expansion slug 652/plug. The drawing 762a illustrates a top-down view, 762b illustrates a side cross-sectional view, 762c illustrates a side view (e.g., without cuts or slots), 762d illustrates a top-down view, 762e illustrates a side view, and 762f illustrates another side view of example balancing expansion slugs 652. In the depicted example, the shapes and sizes may be different. For instance, the center channel may not be straight, the sizes may be different, the bump/ridge may be omitted or revised, or otherwise. The depicted example may have similar lengths and widths to the example of FIG. 7E but may have a mass of approximately 40 grams.

Depending on the implementation, a diameter may be 0.728 inches, as shown in measurement 772a. An interior diameter may be approximately 0.4 to 0.625 inches, as indicated at measurement 772b. A smaller interior diameter at a step down may be approximately 0.25 inches, as indicated at measurement 772c. An overall height may be approximately 1 inch with a slit for an arm approximately 0.6 inches high, as indicated at measurement 772d and 772e, respectively. A cut width, for example, made by a bandsaw, may be 0.075 to 0.15 or wider, as indicated at measurement 772f. Measurements 772g and 772h respectively indicate a width and depth of a slot in the top of a slug 652, which may be 0.125 to 0.25 inches each, though other implementations are possible and contemplated.

It should be noted that numerous specific dimensions are provided, especially in reference to FIGS. 7E and 7F, but these are merely provided as examples and usable values, and that many different configurations, shapes, and sizes are possible and contemplated.

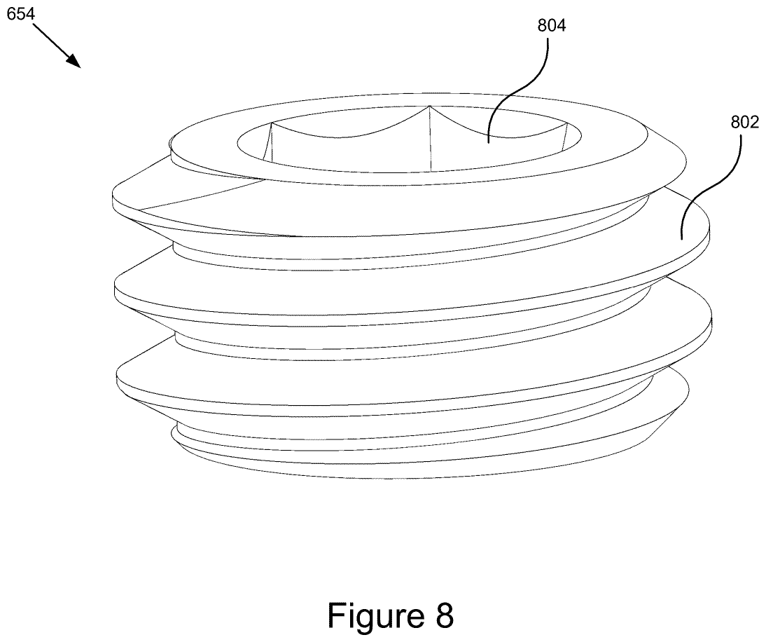

FIG. 8 illustrates an example set screw 654, which may be screwed into the balancing expansion slug 652 using threads 802 in order to increase its weight and/or set the slug 652 into the receptacle 410. For instance, the set screw 654 may be screwed into a center channel 704 of the slug 652 thereby causing the arms/fingers 706 of the slug 652 to flex outward and secure it in the receptacle 410. In some cases, the set screw 654 may span a flex channel 710 (or multiple screws may be used), so that if a finger 706 breaks at the flex channel 710, it continues to be held in place within the center channel 704 even with the break, which further improves safety.

The set screw 654 may screw fully into the center channel 704 or only partially. For instance, various set screws 654 may have different lengths, which causes them to have different weights. Similarly, a set screw 654 may include or may omit a head, which allows it to be fully inserted and/or stacked in the center channel 704 of the expansion slug 652. Other implementations may have the set screw 654 directly screwing into the receptacle 410. In some cases, as noted elsewhere herein, a set screw 654 may couple with a washer 656 and/or nut to further add weight and/or secure it to the receptacle 410.

As shown in the example, the set screw 654 may have an Allen key hole or other tool interface 804 (e.g., Phillips, flat head, hex, etc.) that allow it to be screwed into the center channel of the slug 652. The hole or tool interface may extend fully or partially through the slug 652 depending on implementation and how much weight is desired. Similarly, the length, material, or other parameters of the set screw(s) 654 may be varied to allow different masses to be added to the expansion slug 652.

Set screws 654 of various materials and/or lengths may be stacked in the center channel of the expansion slug 652, which allows their mass to be fine-tuned. For example, 1, 2, 3, 4, or more set screws 654 may be added to the expansion slug 652 to increase its weight and/or holding strength.

In the foregoing description, for purposes of explanation, numerous specific details are set forth in order to provide a thorough understanding of the technology. It will be apparent, however, that the technology described herein can be practiced without these specific details.

Reference in the specification to “one implementation”, “an implementation”, “some implementations”, or “other implementations” means that a particular feature, structure, or characteristic described in connection with the implementation is included in at least one implementation of the disclosure. The appearances of the term “implementation” or “implementations” in various places in the specification are not necessarily all referring to the same implementation.

In addition, it should be understood and appreciated that variations, combinations, and equivalents of the specific implementations, implementations, and examples may exist, are contemplated, and are encompassed hereby. The invention should therefore not be limited by the above-described implementations, implementations, and examples, but by all implementations, implementations, and examples, and other equivalents within the scope and spirit of the invention as claimed.

What is claimed is:

1. A system comprising:
a flywheel including a rotatable mass component and one or more axles coupled with the rotatable mass component, the one or more axles extending from a top of the rotatable mass component and from a bottom of the rotatable mass component, the flywheel including a plurality of receptacles; and
a balancing slug that deforms when placed into one of the plurality of receptacles.

2. The system of claim 1, further comprising:
an enclosure enclosing the flywheel, the enclosure including a balancing access port adjacent to at least one of the plurality of receptacles, the balancing access port allowing the balancing slug to be inserted through the balancing access port.

3. The system of claim 2, wherein:
the enclosure includes a plurality of balancing access ports, the plurality of balancing access ports including the balancing access port on a top of the enclosure and a second balancing access port on a bottom of the enclosure when the enclosure is placed with the one or more axles in a vertical orientation.

4. The system of claim 2, wherein:
the enclosure includes a first plurality of balancing access ports on a top of the enclosure and a second plurality of balancing access ports on a bottom of the enclosure when the enclosure is placed with the one or more axles in a vertical orientation.

5. The system of claim 2, further comprising:
a door closing the balancing access port and one or more seals sealing the door to the enclosure.

6. The system of claim 5, wherein:
the door includes a transparent window.

7. The system of claim 6, further comprising:
the door includes a mirror coupled with the transparent window, the mirror being angled to allow visibility inside the enclosure toward the one or more axles through the transparent window.

8. The system of claim 1, wherein:
the balancing slug includes a circumferential ridge that is constructed from a softer material than a receptacle of the plurality of receptacles of the flywheel, the circumferential ridge deforming when the balancing slug is installed in the receptacle.

9. The system of claim 1, wherein:
the balancing slug includes a plurality of fingers that flex relative to one another, the plurality of fingers being pressed toward a center axis of the balancing slug when the balancing slug is inserted into a receptacle of the plurality of receptacles.

10. The system of claim 1, wherein:
the balancing slug has a substantially cylindrical body, the balancing slug including a center channel extending along a longitudinal axis of the substantially cylindrical body, the center channel receiving at least one weight.

11. The system of claim 10, wherein:
the at least one weight includes a set screw that screws into threads located within the center channel.

12. The system of claim 11, wherein:
the set screw exerts a circumferential force on the center channel when the set screw is screwed into the center channel, the circumferential force causing a surface of the balancing slug to be pressed into a second surface of a receptacle of the plurality of receptacles.

13. The system of claim 11, wherein:
the center channel is configured to receive multiple set screws simultaneously.

14. The system of claim 1, wherein:
each receptacle of the plurality of receptacles includes a recess with a substantially cylindrical shape extending in an axial direction of the flywheel.

15. The system of claim 1, wherein:
the rotatable mass component includes two clamping plates sandwiching a plurality of stacking plates, each of the two clamping plates including the plurality of receptacles.

16. The system of claim 1, wherein:
a first subset of the plurality of receptacles are positioned on a top surface of the rotatable mass component and a second subset of the plurality of receptacles are positioned on a bottom surface of the rotatable mass component.

17. A system comprising:
a flywheel including a rotatable mass component and one or more axles coupled with the rotatable mass component, the one or more axles extending from a top of the rotatable mass component and from a bottom of the rotatable mass component, the flywheel including a plurality of receptacles;
a balancing slug that deforms when placed into one of the plurality of receptacles, the balancing slug including:
a plurality of fingers located around a center channel in a substantially cylindrical body of the balancing slug, the plurality of fingers flexing relative to one another, the plurality of fingers being pressed toward a center axis of the balancing slug when the balancing slug is inserted into a receptacle of the plurality of receptacles, the center channel configured to receive a set screw that exerts a circumferential force on the plurality of fingers when the set screw is placed in the center channel; and
the balancing slug includes a circumferential ridge that is constructed from a softer material than the receptacle of the flywheel, the circumferential ridge deforming when the balancing slug is installed in the receptacle of the plurality of receptacles; and
an enclosure enclosing the flywheel, the enclosure including a balancing access port adjacent to at least one of the plurality of receptacles, the balancing access port allowing the balancing slug to be inserted through the balancing access port.

18. A method of balancing a flywheel comprising:
placing a first balancing slug into a first receptacle on a first plane of the flywheel through a top balancing access port of an enclosure; and
placing a first set screw into the first balancing slug while the first balancing slug is in the first receptacle.

19. The method of claim 18, further comprising:
determining a balance of the flywheel inside of the enclosure; and
based on the balance of the flywheel, placing a second balancing slug into a second receptacle on a second plane of the flywheel through a bottom balancing access port, and placing a second set screw into the second balancing slug while the second balancing slug is in the second receptacle.

20. The method of claim 18, further comprising:
opening a door closing the top balancing access port;
rotating the flywheel within the enclosure until the first receptacle is located proximate to the top balancing access port; and
inserting the first balancing slug into the first receptacle through the top balancing access port of the enclosure.
